(19) United States
(12) Patent Application Publication
(10) Pub. No.: US 2009/0254988 A1
(43) Pub. Date: Oct. 8, 2009

(54) EVALUATION APPARATUS, EVALUATION METHOD, EVALUATION PROGRAM AND INTEGRATED CIRCUIT

(76) Inventors: Masao Nonaka, Osaka (JP); Kaoru Yokota, Hyogo (JP); Natsume Matsuzaki, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/995,787

(22) PCT Filed: Jul. 24, 2006
(86) PCT No.: PCT/JP2006/314592

§ 371 Date: Jan. 15, 2008

(30) Foreign Application Priority Data
Jul. 27, 2005 (JP) 2005-216714

(51) Int. Cl. G06F 21/00

(52) U.S. Cl. 726/22

(57) ABSTRACT

In a system for transmitting/receiving information, each of users of terminals subjectively determines a direct evaluation value of a party that the user knows personally and so on. Since the direct evaluation value determined in this way changes depending on the subjective evaluation criterion, the direct evaluation value is not generated based on the single evaluation criterion. In view of this, a terminal device 100A according to the present invention prestores therein content evaluation values respectively corresponding to pieces of content data that are stored therein. When transmitting a piece of content data to a terminal device, the terminal device 100A generates an entity evaluation value of the terminal device that is a transmission destination based on a content evaluation value of the transmitted piece of content data.

### TECHNICAL FIELD

The present invention relates to an art for generating an evaluation value that represents an evaluation of a user of a terminal device participating in a system.

### BACKGROUND ART

Recently, services using peer-to-peer systems have been attracting attention. For example, the services include online auction services in which users on a network can trade various commodities with each other and file exchange services in which users on a network can exchange contents and programs with each other.

In such services, since the users might purchase commodities or receive contents and programs from an unknown party, there is a case that the users cannot know whether the party is a reliable entity (a person, a terminal, etc.). Therefore, a criterion for reliability of entities on the network is needed in such a case.

As an art satisfying such a need, Nonpatent Document 1 discloses an art for determining an evaluation value of an unknown party, as an art for use in a peer-to-peer system that does not include any server. Such an art is generally called “trustmetric”. In this art, as the first step, each user sets an evaluation value of an entity that the user can evaluate, such as an entity with which the user has ever dealt and an entity that the user knows personally (herein after referred to as a “direct evaluation value”. The direct evaluation value is for example a numeric value from 0 to 1 representing the degree of reliability of the entity.). Then, as the second step, the user calculates an evaluation value of an entity that the user cannot evaluate, by using an evaluation value of the entity set by other users (herein after referred to as an “indirect evaluation value”). According to this art, it is possible to acquire an evaluation value of an entity that the user does not know personally. The user participating in the system can exchange information and so on more safely with an entity that the user does not know, by reference to an indirect evaluation value of the entity acquired in such a way.

[Nonpatent Document 1] Thomas Beth, Malte Borcherding, Birgit Klein, “Valuation of Trust in Open Networks”, and Third European Symposium on Research in Computer Security (ESORICS94).

### DISCLOSURE OF THE INVENTION

### Problems the Invention is Going to Solve

According to the above art, a user of a terminal sets direct evaluation values respectively corresponding to entities that the user can evaluate directly. The user sets the direct evaluation values in accordance with a criterion subjectively determined by the user. Since it is considered that the user often relies on temporary feeling or instinct to set the direct evaluation values, the criterion for the evaluation values changes depending on change of the user's feeling and the like. Therefore, the entity evaluation values of the entities are hardly determined based on a uniform criterion.

In the above art disclosed in Nonpatent Document 1, since an indirect evaluation value is calculated using a direct evaluation value determined based on a ununiform criterion, the calculated indirect evaluation value might be improper.

In view of the above problem, the present invention aims to provide an evaluation device, an evaluation method, an evaluation program, and an integrated circuit that can generate a direct evaluation value based on a uniform criterion.

### Means to Solve the Problems

In order to solve the above problem, the present invention provides an evaluation device that generates an evaluation value representing an evaluation of an owner of a terminal device to which data is transmitted, the evaluation device comprising: a storage unit that stores therein one or more pieces of data and data evaluation values respectively corresponding thereto; a terminal designation unit operable to receive designation of a terminal device from an operator of the evaluation device; a data designation unit operable to receive designation of a piece of data to be transmitted to the designated terminal device from the operator, the piece of data being included in the stored pieces of data; and a generation unit operable to generate an evaluation value of an owner of the designated terminal device, based on a data evaluation value corresponding to the designated piece of data.

Here, the above “evaluation device” corresponds to a terminal device 100A in a first embodiment described below. Also, in the first embodiment, functions of the “storage unit” are achieved by a storage unit 110. Functions of the “terminal designation unit” and the “data designation unit” are achieved by an input unit 106. Functions of the “generation unit” are achieved by the storage unit 110 and an entity evaluation value derivation unit 156.

### EFFECT OF THE INVENTION

With this structure, the generation unit generates the evaluation value of the owner, based on the data evaluation value corresponding to the piece of data designated to be transmitted to the designated terminal device.

As described above, by generating an evaluation value of an owner of a terminal device using a data evaluation value of a piece of data to be transmitted to the terminal device, the evaluation device of the present invention can generate the evaluation value, without being influenced by change of the operator's feeling during the generation, based on a uniform criterion, i.e., the data evaluation value.

The storage unit included in the evaluation device stores therein the data evaluation values determined by the operator.

With this structure, the data evaluation values are determined by the operator of the evaluation device. Also, designation of a piece of data to be transmitted to a terminal device is received from the operator. Therefore, the evaluation device of the present invention can generate an evaluation value of an owner of the terminal device that surely reflects the operator's intention.

Also, the generation unit included in the evaluation device selects, as the evaluation value of the owner, a highest value among the data evaluation value corresponding to the designated piece of data and a data evaluation value corresponding to a piece of data that has ever been designated to be transmitted to the designated terminal device.

With this structure, the generation unit selects, as an evaluation value of an owner of a terminal device, a highest value among data evaluation values respectively corresponding to pieces of data that have ever been designated to be transmitted to the terminal device. Therefore, the evaluation device of the present invention can evaluate an owner of a terminal device higher, to which a piece of data corresponding to a higher data evaluation value such as a piece of data having important contents, without being influenced by the number of the pieces of data that have ever been transmitted.

Also, the generation unit included in the evaluation device includes: an old evaluation value storage sub-unit that stores therein an old evaluation value representing an evaluation of the owner that has been generated before the data designation unit and the terminal designation unit receive the designation of the terminal device and the piece of data; a comparison sub-unit operable to compare the old evaluation value with the data evaluation value corresponding to the designated piece of data, and select a highest value of the old evaluation value and the data evaluation value, as the evaluation value of the owner; and an updating sub-unit operable to update the old evaluation value to the selected evaluation value.

Alternatively, the generation unit may include: an old evaluation value storage sub-unit that stores therein an old evaluation value representing an evaluation of the owner that has been generated before the data designation unit and the terminal designation unit receive the designation of the terminal device and the piece of data; a calculation sub-unit operable to calculate a sum of the old evaluation value and the data evaluation value corresponding to the designated piece of data; and an updating sub-unit operable to update the old evaluation value to the calculated sum.

With this structure, the updating sub-unit generates an evaluation value of the owner of the terminal device each time the data designation unit designates a piece of data to be transmitted to the terminal device. Therefore, the evaluation device of the present invention can always generate an evaluation value of an owner of a terminal device to which data is transmitted, the evaluation value reflecting the latest intention of the operator of the evaluation device.

Also, the generation unit included in the evaluation device includes: a history storage sub-unit that stores therein history information indicating the piece of data that has ever been designated to be transmitted to the designated terminal device; and a selection sub-unit operable to select the highest value among the data evaluation value corresponding to the designated piece of data and the data evaluation value corresponding to the piece of data indicated by the history information.

Alternatively, the generation unit may include: a history storage sub-unit that stores therein history information indicating the piece of data that has ever been designated to be transmitted to the designated terminal device; and a calculation sub-unit operable to calculate a sum of the data evaluation value corresponding to the piece of data indicated by the history information and the data evaluation value corresponding to the designated piece of data.

With this structure, the generation unit includes the history storage sub-unit. The selection sub-unit generates the evaluation value using the history information stored in the history storage sub-unit. Accordingly, the specification sub-unit does not need to generate the evaluation value each time the data designation unit designates a piece of data. As a result, the number of calculations of the evaluation value can be reduced.

Also, the generation unit included in the evaluation device generates, as the evaluation value of the owner, a sum of the data evaluation value corresponding to the designated piece of data and a data evaluation value corresponding to a piece of data that has ever been designated to be transmitted to the designated terminal device.

It is often the case that if the number of times of data transmission to an owner of a terminal device is more, the owner is higher evaluated by the operator. Also, it is considered that an owner of a terminal device to which important data is transmitted is higher evaluated by the operator even if the number of times of data transmission to the owner is less. With this structure, the generation unit determines, as the evaluation value of the owner, the sum of the data evaluation value corresponding to the piece of data that has ever been designated to be transmitted to the terminal device. Therefore, it is possible to higher evaluate a party corresponding to either of the above two cases.

Also, the present invention provides the evaluation device further comprising: an acquisition unit operable to acquire a piece of data relating to the owner; and an evaluation value generation unit operable to generate an evaluation value of the owner in accordance with a data type of the acquired piece of data.

Here, the above “evaluation device” corresponds to a terminal device 300 in a second embodiment described below. Also, functions of the “acquisition unit” are achieved by an antenna 101, a transmission/reception unit 102, a profile reception processing unit 373, an input unit 106, and an other-terminal profile registration unit 374 in the second embodiment described below. Functions of the “evaluation value generation unit” are achieved by a storage unit 310 and an entity evaluation value derivation unit 376 in the second embodiment.

With this structure, the evaluation value generation unit generates the evaluation value in accordance with the data type of the piece of data acquired by the acquisition unit. As a result, the evaluation device of the present invention can generate an evaluation value of an owner of a terminal device based on a data evaluation value determined in accordance with a data type of a piece of data to be transmitted to the terminal device, which is a uniform criterion, without being influenced by change of feeling of the operator of the evaluation device during the generation of the evaluation value.

Also, the evaluation value generation unit included in the evaluation device includes: a type evaluation value storage sub-unit that stores therein one or more type evaluation values respectively corresponding to one or more data types; and a calculation sub-unit operable to read a type evaluation value corresponding to the data type of the acquired piece of data among the type evaluation values stored in the type evaluation value storage sub-unit, and calculate the evaluation value of the owner using the read type evaluation value.

With this structure, the calculation sub-unit can promptly generate the evaluation value by using the type evaluation value prestored in the type evaluation value storage unit.

Also, the acquisition unit included in the evaluation device acquires the piece of data that is personal data of the owner.

Here, the above “personal data of the owner” is data including private information such as the owner's name, address, and phone number, for example.

Such data can be a material for judging what kind of the owner is. Since the owner discloses such data, the evaluation device can judge that the owner is a reliable person. With the above structure, the evaluation value generation unit generates the evaluation value of the owner using the personal data thereof. As a result, the evaluation device of the present invention can higher evaluate such a party.

The evaluation device further comprises an input unit operable to receive the type evaluation value input by the operator, wherein the type evaluation value storage unit stores therein the type evaluation value received by the input unit.

With this structure, since the evaluation device of the present invention receives input of the type evaluation value from the operator, the evaluation device can generate the evaluation value that reflects the intention of the operator.

The acquisition unit included in the evaluation device acquires the piece of data including an identifier indicating the data type thereof, the type evaluation values stored in the type evaluation value storage unit respectively correspond to identifiers respectively indicating the data types, and the calculation sub-unit reads the type evaluation value corresponding to the identifier included in the acquired piece of data.

With this structure, the calculation sub-unit can easily and promptly read, based on the identifier, the type evaluation value corresponding to the data type of the acquired piece of data.

The acquisition unit included in the evaluation device acquires the piece of data relating to the owner by receiving from the designated terminal device via a network or receiving input by the operator, and the calculation sub-unit calculates the evaluation value of the owner using a product of the type evaluation value corresponding to the data type of the acquired piece of data and a specific gravity value corresponding to a method for acquiring the piece of data.

There is a case that an evaluation of a party differs depending on an acquisition path of a piece of data relating to the party. Furthermore, there is a case that credibility of a piece of data differs depending on acquisition path thereof. In order to address the above cases, it is sometimes necessary to change an evaluation of a party depending on an acquisition path of a piece of data relating to the party.

For example, if a party willingly transmits personal data relating thereto to the evaluation device, the evaluation device higher evaluates the person. If the operator of the evaluation device inputs, to the evaluation device, data relating to a party acquired by the operator via a third person, the evaluation device lower evaluates the party. On the other hand, the following may be employed. Since data transmitted to the evaluation device via a network has lower credibility, the evaluation device lower evaluates a party relating to the transmitted data. Also, if the operator inputs data relating to a party that the operator has heard firsthand from the party, the evaluation device highly evaluates the party.

With the above structure, the acquisition unit can acquire the piece of data relating to the owner of the terminal device using any one of the methods including reception from the terminal device via the network and input by the operator of the evaluation device. The calculation sub-unit calculates the evaluation value of the owner using the product of the type evaluation value corresponding to the data type of the acquired piece of data and the specific gravity value determined in accordance with the method of acquiring the piece of data. Accordingly, if there is a difference in credibility of a piece of data depending on acquisition path thereof as described above, it is possible to generate an evaluation value of an owner of a terminal device to which the piece of data is transmitted, by weighting in accordance with the difference.

The evaluation value generation unit included in the evaluation device includes: a type evaluation value storage sub-unit that stores therein one or more type evaluation values respectively corresponding to one or more data types; and an old evaluation value storage sub-unit that stores therein an old evaluation value representing an evaluation of the owner generated in accordance with one or more data types of one or more pieces of data relating to the owner that have ever been acquired; a judgment sub-unit operable to judge whether the data type of the acquired piece of data matches the data types of the pieces of data that have ever been acquired; and a calculation sub-unit operable, (i) if the judgment sub-unit judges negatively, to read a type evaluation value corresponding to the data type of the acquired piece of data from the type evaluation value storage unit, and calculate the evaluation value of the owner based on the read type evaluation value and the old evaluation value, and (ii) if the judgment sub-unit judges affirmatively, to determine the old evaluation value as the evaluation value of the owner.

With this structure, only if the judgment sub-unit judges that the data type of the acquired piece of data matches the data type of the piece of data that has ever been acquired, the calculation sub-unit re-calculates the evaluation value of the owner using the type evaluation value corresponding to the data type of the acquired piece of data. Therefore, even if the same piece of data is transmitted from the terminal device a plurality of times in order to maliciously increase the evaluation value of the owner, the evaluation device does not generate a high evaluation value of the owner.

### BRIEF DESCRIPTION OF THE DRAWINGS

FIG. 1 shows the structure of an information distribution system according to a first embodiment;

FIG. 2 is a block diagram showing the structure of a terminal device 100A;

FIG. 3 shows an example of information stored in a storage unit 110;

FIG. 4 shows the details of an other-terminal information table 131;

FIG. 5 shows the details of a distribution condition table 141;

FIG. 6 shows the details of a content evaluation value table 145;

FIG. 7 shows an example of an other-terminal information registration screen 171;

FIG. 8 shows an example of a content selection screen 191;

FIG. 9 shows an example of a content information setting screen 181;

FIG. 10 shows an example of a transmission destination selection screen 201;

FIG. 11 shows an example of a receiving screen 211;

FIG. 12 is a flow chart showing operations of the terminal device 100A;

FIG. 13 is a flow chart showing content data acquisition processing performed by a content acquisition unit 152, which shows the details of Step S123 in FIG. 12;

FIG. 14 is a flow chart showing other-terminal information registration processing, which shows the details of Step S124 in FIG. 12;

FIG. 15 is a flow chart showing content information setting processing, which shows the details of Step S126 in FIG. 12;

FIG. 16 is a flow chart showing content data transmission processing, which shows the details of Step S127 in FIG. 12;

FIG. 17 is a flow chart showing content data transmission processing performed by a transmission processing unit 157, which shows the details of Step S191 in FIG. 16;

FIG. 18 is a flow chart showing entity evaluation value update processing performed by an entity evaluation value derivation unit 156, which shows the details of Step S192 in FIG. 16;

FIG. 19 is a flow chart showing content reception processing, which shows the details of Step S116 in FIG. 12;

FIG. 20 is a block diagram showing the functional structure of a terminal device 300 according to a second embodiment;

FIG. 21 shows an example of information stored in a storage unit 310;

FIG. 22 shows an example of the structure of a user profile table 323;

FIG. 23 shows the details of an other-terminal profile table 331;

FIG. 24 shows the details of a profile evaluation value table 361;

FIG. 25 shows an example of a profile evaluation value input screen 401;

FIG. 26 shows an example of a transmission profile selection screen 421;

FIG. 27 shows an example of an other-terminal profile input screen 411;

FIG. 28 is a flow chart showing operations of the terminal device 300;

FIG. 29 is a flow chart showing profile evaluation value setting processing performed by a profile evaluation value setting unit 371, which shows the details of Step S316 in FIG. 28;

FIG. 30 is a flowchart showing profile transmission processing, which shows the details of Step S317 in FIG. 28;

FIG. 31 is a flow chart showing profile reception processing, which shows the details of Step S309 in FIG. 28;

FIG. 32 is a flow chart showing other-terminal profile registration processing, which shows the details of Step S321 in FIG. 28;

FIG. 33 is a flow chart showing entity evaluation value update processing, which shows the details of Step S387 in FIG. 31 and Step S416 in FIG. 32;

FIG. 34 shows the details of a position evaluation value table 501;

FIG. 35 shows the details of a date evaluation value table 511;

FIG. 36 shows an example of a registration item selection screen 521; and

FIG. 37 shows the details of an additional evaluation value table 512.

### DESCRIPTION OF CHARACTERS

100A: terminal device
101: antenna
102: transmission/reception unit
103: drive unit
104: call processing unit
105: bus
106: input unit
107: control unit
109: display unit
110: storage unit
151: other-terminal information setting unit
152: content acquisition unit
153: content information setting unit
154: transmission content selection unit
156: entity evaluation value derivation unit
157: transmission processing unit
158: reception processing unit
300: terminal device
371: profile evaluation value setting unit
372: profile transmission processing unit
373: profile reception processing unit
374: other-terminal profile registration unit
376: entity evaluation value derivation unit
378: user profile setting unit

### BEST MODE FOR CARRYING OUT THE INVENTION

### 1. First Embodiment

The following describes a first embodiment according to the present invention with reference to the drawings.

### 1.1 Outline of Information Distribution System 1

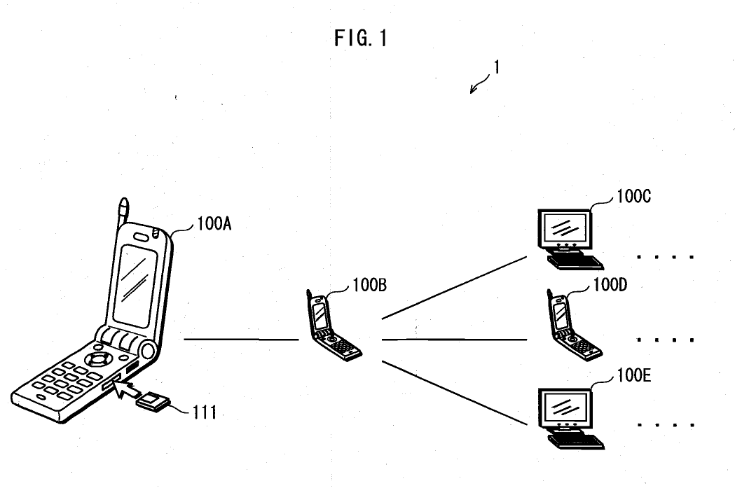

An information distribution system 1 includes a plurality of terminal devices 100A, 100B, 100C, . . . , as shown in FIG. 1. The terminal devices are connected with each other via a communication path such as a mobile phone network and the Internet.

Each of the terminal devices 100A, 100B, 100C, . . . included in the information distribution system 1 is specifically a so-called information processing terminal device capable of performing processing such as input, output, and storage of information. The information processing terminal device is, for example, a computer device such as a personal computer, a home electric appliance (a digital television, a video cassette recorder, a DVD recorder, a hard disk recorder, etc.), a set top box, a mobile phone, a PHS, a digital still camera, a digital video camera, a multimedia playback terminal, a PDA (Personal Digital Assistant: mobile information terminal device), a dedicated mobile terminal.

Also, data transmission/reception is performed via the communication path that connects the terminal devices with each other through the procedure in conformity with the communication protocol such as TCP/IP.

The terminal device 100A stores therein entity evaluation values respectively corresponding to some of the terminal devices included in the information distribution system 1. Each of the entity evaluation values is a numeric value representing a result of an evaluation of a user of a corresponding terminal device performed by a user of the terminal device 100A. Here, the evaluation may be performed with respect to reliability of the user of the terminal device or with respect to familiarity of the user of the terminal device, for example.

The user of the terminal device 100A creates a piece of content data using a digital camera or a personal computer, and stores the created piece of content data in a memory card 111.

The memory card 111 can be inserted into the terminal device 100A, and the terminal device 100A acquires the piece of content data from the memory card 111 and stores therein the acquired piece of content data. Furthermore, the terminal device 100A stores therein pieces of content data received from other terminal devices. Moreover, the terminal device 100A stores therein, for each piece of content data, a distribution threshold for determining whether secondary distribution of the piece of content data is permitted. In the following description, the secondary distribution means that content data received by the terminal device 100A from another terminal device is transferred to yet another terminal device. Also, on the other hand, primary distribution indicates that content data acquired by the terminal device 100A from the memory card 111 or created by the terminal device 100A is transmitted to another terminal device.

When transmitting a piece of content data to another terminal device, the terminal device 100A firstly judges whether transmission of the piece of content data is primary distribution or secondary distribution. If the transmission is the primary distribution, the terminal device 100A transmits the piece of content data regardless of a distribution threshold thereof. If the transmission is the secondary distribution, the terminal device 100A compares the distribution threshold of the piece of content data with an entity evaluation value of a terminal device to which the piece of content data is to be transmitted. Only if the entity evaluation value is no less than the distribution threshold, the terminal device 100A transmits the piece of content data to the terminal device.

The terminal device 100A further stores therein content evaluation values respectively corresponding to the pieces of content data. Each of the content evaluation values represents a value subjectively set by the user of the terminal device 100A regardless of a source of the piece of content data corresponding to the content evaluation value.

When transmitting a piece of content data, the terminal device 100A compares an entity evaluation value of a terminal device that is a transmission-destination with a content evaluation value of the transmitted piece of content data. If the content evaluation value is greater than the entity evaluation value, the terminal device 100A replaces the entity evaluation value with the content evaluation value. Each time the terminal device 100A transmits a piece of content data, the terminal device 100A repeatedly performs the comparison and the update as described above. Accordingly, the entity evaluation value of the terminal device matches the highest value among content evaluation values of pieces of content data that have ever been transmitted to the terminal device.

Each of the terminal devices 100B, 100C, . . . also has the same functions as those of the terminal device 100A, and therefore the following explains only the terminal device 100A.

Here, the terminal device 100A transmits a piece of content data selected by the user thereof to another terminal device. For example, the terminal device 100A transmits/receives the piece of content data as an electronic mail attachment. However, in the following description, the explanation for electronic mail creation processing such as creation of electronic mail texts and attachment of content data is omitted for simplification. Such electronic mail creation processing is represented as just transmission (or reception) of content data.

### 1.2 Structure of Terminal Device 100A

Here, the terminal device 100A is a mobile phone, for example. Moreover, the terminal device 100A is a terminal device that transmits/receives data, and also is an evaluation device that generates entity evaluation values used for controlling data distribution.

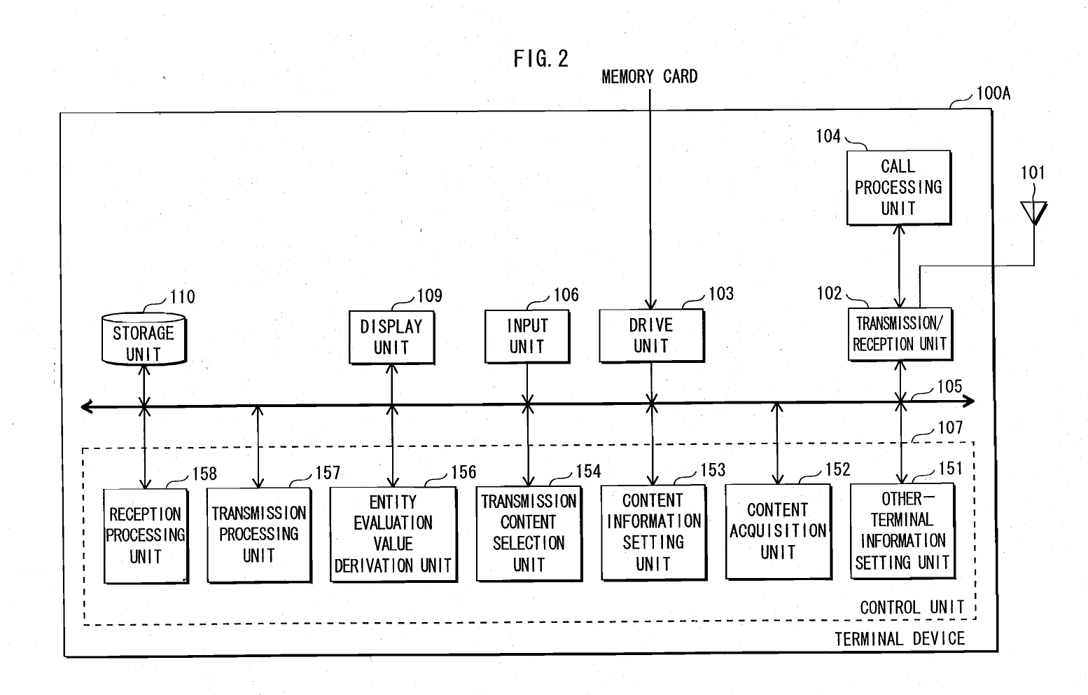

FIG. 2 is a block diagram showing the functional structure of the terminal device 100A. The terminal device 100A includes, as shown in FIG. 2, an antenna 101, a transmission/reception unit 102, a drive unit 103, a call processing unit 104, an input unit 106, a control unit 107, a display unit 109, and a storage unit 110. Each of the compositional elements is connected with the control unit 107 via a bus 105.

The control unit 107 is specifically a computer system including a RAM, a ROM, and a microprocessor. A computer program is stored in the RAM and the ROM. Part of the functions of the terminal device 100A is achieved by the microprocessor operating in accordance with the computer program.

The following describes the compositional elements of the terminal device 100A.

(1) Storage Unit 110

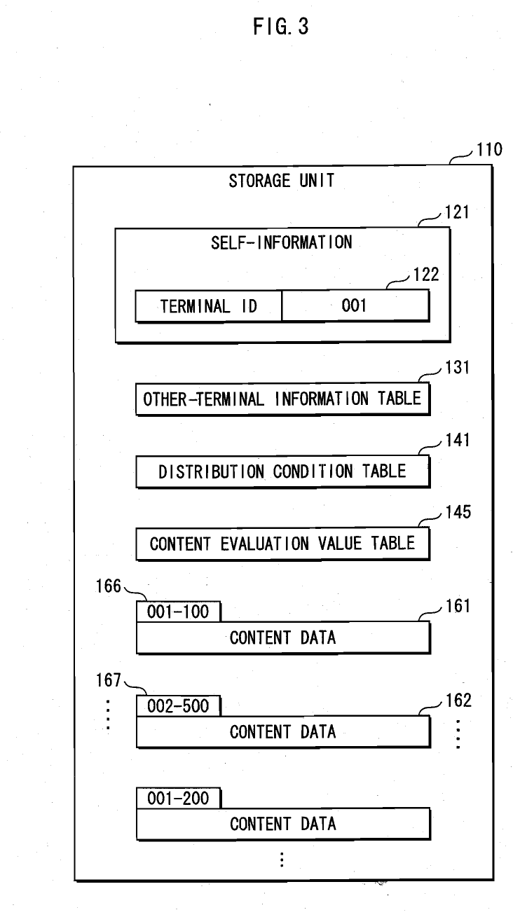

The storage unit 110 includes a hard disk and a RAM. FIG. 3 shows an example of information stored in the storage unit 110.

The storage unit 110 stores therein, as shown in FIG. 3, self-information 121, an other-terminal information table 131, a distribution condition table 141, a content evaluation value table 145, and pieces of content data 161, 162, . . . , and content IDs 166, 167, . . . .

The self-information 121 includes a terminal ID 122. The terminal ID 122 is a natural number from 0 to 999, and uniquely indicates the terminal device 100A. In the present description and drawings, the terminal ID 122 is represented as a three-digit decimal number for convenience of explanation. However, the terminal ID 122 is actually a 10-bit string.

The self-information 121 here includes only the terminal ID 122. However, the present invention is not limited to this structure, and the self-information 121 may include other information relating to the terminal device 100A (such as an owner name, an address, and a phone number).

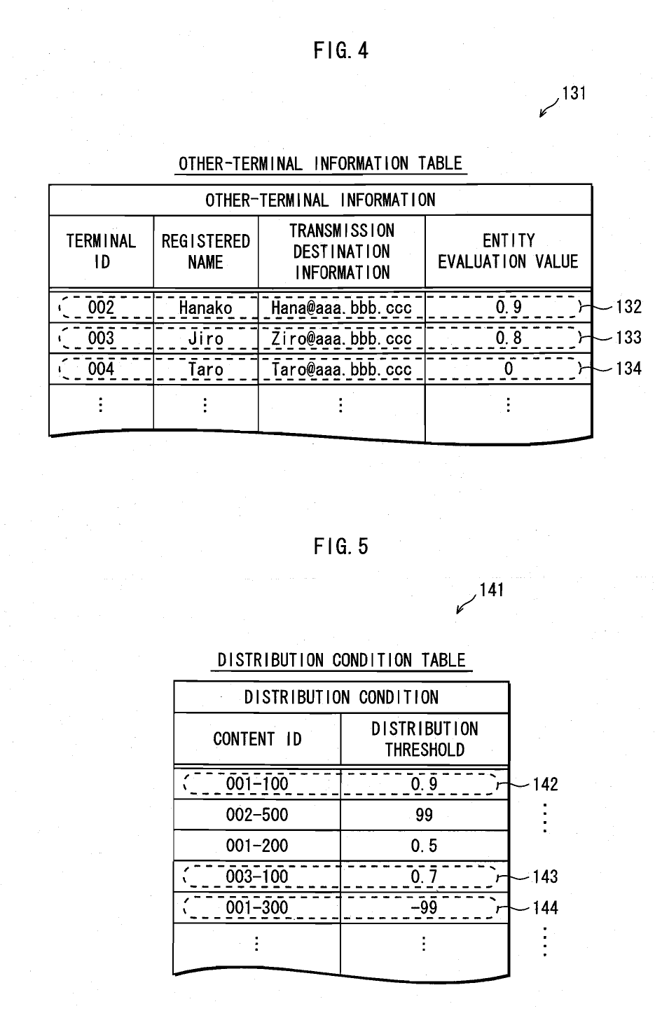

FIG. 4 shows an example of the data structure of the other-terminal information table 131. As shown in FIG. 4, the other-terminal information table 131 includes pieces of other-terminal information 132, 133, 134, . . . . Each of the pieces of other-terminal information corresponds to any one of the terminal devices 100B, 100C, . . . included in the information distribution system 1, i.e., any one of the terminal devices other than the terminal device 100A.

Each of the pieces of other-terminal information is composed of a terminal ID, a registered name, transmission destination information, and an entity evaluation value. The terminal ID is identification information that uniquely indicates a terminal device corresponding to the piece of other-terminal information. Although expressed as a three-digit natural number here, the terminal ID is actually a 10-bit string. The registered name is a name of a user of the terminal device corresponding to the piece of other-terminal information. The transmission destination information indicates a position of the corresponding terminal device on the network. Here, the transmission destination information is an electronic mail address of the corresponding terminal device, for example. The transmission destination information is not limited to the electronic mail address. Alternatively, a TCP/IP host name, an IP address, a MAC address, or the like may be employed for example. The entity evaluation value is the highest value among content evaluation values (described in detail later) respectively corresponding to pieces of content data that have ever been transmitted to the corresponding terminal device. The entity evaluation value is a value from 0 to 1.0, and has a value “0” as the initial value.

The distribution condition table 141 is used by the transmission content selection unit 154 (described later) for judging whether transmission of each piece of content data is permitted. FIG. 5 shows the details of the distribution condition table 141. As shown in FIG. 5, the distribution condition table 141 is composed of distribution conditions 142, 143, 144, . . . .

The distribution conditions respectively correspond to pieces of content data 161, 162, . . . stored in the storage unit 110. Moreover, the distribution conditions respectively correspond to the pieces of content evaluation value information included in content evaluation value table 145, which is described later. Each of the distribution conditions includes a content ID and a distribution threshold.

The content ID is identification information that uniquely indicates a piece of content data corresponding to the distribution condition. In the first embodiment, the content ID is generated for example by combining two natural numbers “X” and “Y”, which are no less than “0” (expressed as “X-Y”). The natural number “X” is a terminal ID of a terminal device that is a destination source of the corresponding piece of content data. That is, the natural number “X” is a terminal ID of a terminal device that has acquired the piece of content data from a recording medium such as the memory card 111, or that has generated the piece of content data by itself.

The natural number “Y” is a three-digit serial number (for example, increased by one in order, “101”, “102”, . . . ) generated by the terminal device indicated by the terminal ID “X”.

For example, a content ID 166 “001-100” indicating the content data 161 is generated by combining the terminal ID 122 “001” indicating the terminal device 100A and a serial number “100” generated by the terminal device 100A.

The distribution threshold is a value for determining whether secondary distribution of the corresponding piece of content data is permitted. If a terminal device has an entity evaluation value that is no less than the distribution threshold, it is possible to transmit the piece of content data to the terminal device. The entity evaluation value is a value from 0 to 1.0, or ±99. The distribution threshold “+99” indicates that transmission of the piece of content to any terminal device is prohibited regardless of an entity evaluation value of a terminal device that is a transmission destination. A distribution threshold “−99” indicates that no distribution threshold is set. A distribution threshold from “0” to “1.0” indicates that transmission of the piece of content is permitted only if a terminal device that is a transmission destination has an entity evaluation value no less than the distribution threshold.

A distribution threshold included in a distribution condition corresponding to a piece of content data acquired by the terminal device 100A from the memory card 111 (specifically, a piece of content data corresponding to a content ID whose top three digits match the terminal ID 122 “001”) is set by the user of the terminal device 100A. On the other hand, a distribution threshold included in a distribution condition corresponding to a piece of content data received by the terminal device 100A from another terminal device (specifically, a piece of content data corresponding to a content ID whose top three digits do not match the terminal ID 122 “001”) is received together with the corresponding piece of content data. Accordingly, the distribution threshold can be neither set nor changed by the terminal device 100A.

The content evaluation value table 145 is information used for determining an entity evaluation value of a terminal device indicated by a piece of other-terminal information registered in the other-terminal information table 131. FIG. 6 shows the details of the content evaluation value table 145. As shown in FIG. 6, the content evaluation value table 145 is composed of a plurality of pieces of content evaluation value information 146, . . . , 147, 148, . . . . The pieces of content evaluation value information respectively correspond to the pieces of content data 161, 162, . . . stored in the storage unit 110. Also, the pieces of content evaluation value information respectively correspond to the distribution conditions constituting the distribution condition table 141. Each of the pieces of the content evaluation value information includes a content ID and a content evaluation value.

The content evaluation value is a decimal number from 0 to 1 that represents an evaluation of a corresponding piece of content data performed by the user. An initial value of the content evaluation value is “0”. A greater content evaluation value represents a higher evaluation of a corresponding piece of content data. Here, the content evaluation value is determined based on a subjective evaluation of the corresponding piece of content data performed by the user of the terminal device 100A. Setting of a criterion for the evaluation is left to the user's discretion. For example, the degree of importance of the piece of content data, the degree of confidentiality of the piece of content data, and the like are set as the criterion for the evaluation.

Each of the pieces of content data 161, 162, . . . is for example a photograph in JPEG format, a moving image in MPEG format, and the like. The content IDs 166, 167, . . . and the pieces of content data 161, 162, . . . are stored in the storage unit 110 in one to one correspondence with each other.

Furthermore, although not specifically shown in the figure, the storage unit 110 stores therein, in addition to the above described information, various kinds of screen data, sound data, text data, programs, and so on, which are used by the control unit 107.

(2) Antenna 101 and Transmission/Reception Unit 102

The transmission/reception unit 102 transmits/receives, via the communication path and the antenna 101, various kinds of information and sound signals between other terminal devices and each of the control unit 107 and the call processing unit 104.

(3) Drive Unit 103

The memory card 111 such as an SD card can be inserted into the drive unit 103, and the drive unit 103 reads data from the memory card 111. The drive unit 103 reads content data recorded in the memory card 111 under control of the control unit 107.

(4) Input Unit 106

The input unit 106 includes operation buttons such as a ten key, direction keys, a determine button, and a menu button, and outputs operation instruction information indicating the user's key operations to the control unit 107.

(5) Display Unit 109

The display unit 109 includes a liquid crystal display and so on, and displays various kinds of screens in accordance with instructions by the control unit 107.

(6) Call Processing Unit 104

The call processing unit 104 includes a microphone, a speaker, a baseband processing circuit, a modulator-demodulator, and an amplifier. The call processing unit 104 performs sound communication between the terminal device 100A and external devices via the antenna 101 and the transmission/reception unit 102.

(7) Control Unit 107

FIG. 2 shows the functional structure of the control unit 107. The control unit 107 includes, as shown in FIG. 2, an other-terminal information setting unit 151, a content acquisition unit 152, a content information setting unit 153, a transmission content selection unit 154, an entity evaluation value derivation unit 156, a transmission processing unit 157, and a reception processing unit 158.

Each of the functional units included in the control unit 107 is achieved by the microprocessor executing a program. In the program, procedures are described such as a procedure of other-terminal information setting processing, a procedure of content data acquisition processing, a procedure of content evaluation value setting processing, a procedure of transmission content selection processing, a procedure of entity evaluation value determination processing, a procedure of transmission processing, and a procedure of reception processing. Note that each of the functional units may be realized by an independent microcomputer.

Furthermore, although not specifically shown in the figure, the control unit 107 includes various kinds of programs including procedures of other processing (for example, processing in start-up, processing during standby, and processing of changing or registering various kinds of settings), and also includes functions for various kinds of processing. Hereinafter, processing that is not performed by any of the following compositional units is described merely as processing performed by the “control unit 107”. The compositional units include the other-terminal information setting unit 151, the content acquisition unit 152, the content information setting unit 153, the transmission content selection unit 154, the entity evaluation value derivation unit 156, the transmission processing unit 157, and the reception processing unit 158.

The control unit 107 receives operation instruction information indicating press of the menu button from the input unit 106. Upon receiving the operation instruction information indicating the press of the menu button, the control unit 107 generates, based on screen data stored in the storage unit 110, a menu screen having listed thereon various kinds of functions of the terminal device 100A (such as acquisition of content data, registration of other-terminal information, and transmission of content data), and displays the generated menu screen on the display unit 109. Next, the control unit 107 receives the user's selection of a menu via the input unit 106. Upon receiving operation instruction information indicating the user's selection, each of the functional units of the control unit 107 performs processing as described below in accordance with the received operation instruction information.

Moreover, upon detecting reception of content data from another terminal device via the antenna 101 and the transmission/reception unit 102, the reception processing unit 158 performs content reception processing as described below.

The following describes the functional units in detail.

(7-1) Contents Acquisition Unit 152

The content acquisition unit 152 includes a counter that counts serial numbers. Each time the content acquisition unit 152 acquires a new piece of content data, the content acquisition unit 152 counts up a value of the counter by one.

Moreover, the content acquisition unit 152 prestores therein a distribution threshold “−99” indicating that no distribution threshold is set, and a value of “0” as an initial value of a content evaluation value.

The content acquisition unit 152 receives, from the input unit 106, operation instruction information for instructing to acquire a piece of content data. Upon receiving the operation instruction information for instructing to acquire the piece of content data, the content acquisition unit 152 reads the piece of content data from the memory card 111 via the drive unit 103.

After reading the piece of content data, the content acquisition unit 152 reads the terminal ID 122 from the storage unit 110. Then, the content acquisition unit 152 adds a value “1” to the counter included therein, and sets a value after the addition as a serial number.

Next, the content acquisition unit 152 combines the read terminal ID 122 and the serial number to generate a content ID. The content acquisition unit 152 writes the generated content ID and the read piece of content data into the storage unit 110 in correspondence with each other.

Next, the content acquisition unit 152 generates a distribution condition composed of the generated content ID and the prestored distribution threshold “−99”, and adds the generated distribution condition to the distribution condition table 141. Then, the content acquisition unit 152 generates a piece of content evaluation value information composed of the generated content ID and the prestored content evaluation value “0”, and adds the generated piece of content evaluation value information to the content evaluation value table 145.

Here, the terminal device 100A may include a photographing function. In such a case, each time the terminal device 100A generates a new piece of content data and stores therein the generated piece of content data, the terminal device 100A generates a new distribution condition and a new piece of content evaluation value information, and adds the generated distribution condition and the generated piece of content evaluation value information to the distribution condition table 141 and the content evaluation value table 145, respectively, in the same way as described above.

(7-2) Other-Terminal Information Setting Unit 151

The other-terminal information setting unit 151 prestores therein a value “0” as an initial value of an entity evaluation value.

The other-terminal information setting unit 151 receives, from the input unit 106, operation instruction information for instructing to register a new piece of other-terminal information. Upon receiving the operation instruction information for instructing to register the new piece of other-terminal information, the other-terminal information setting unit 151 reads the screen data stored in the storage unit 110, generates an other-terminal information registration screen based on the read screen data, and displays the generated other-terminal information registration screen on the display unit 109.

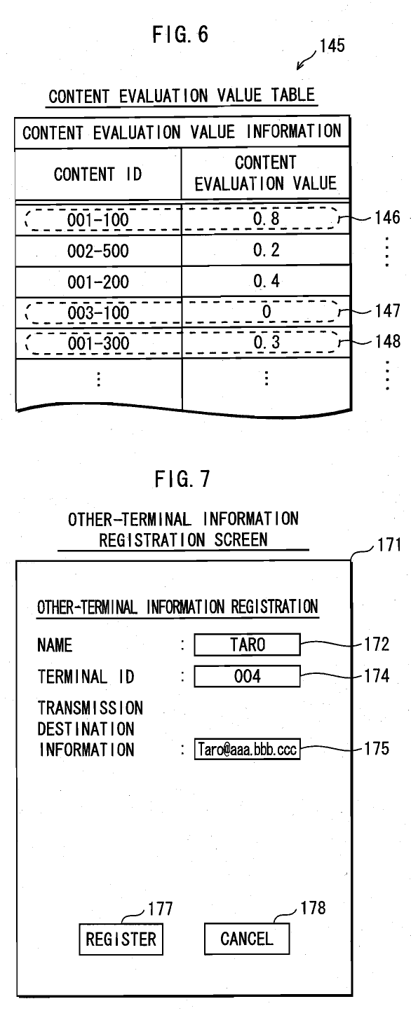

FIG. 7 shows an example of the other-terminal information registration screen 171 generated here. The other-terminal information registration screen 171 includes a registered name input field 172, a terminal ID input field 174, a transmission destination information input field 175, a register button 177, and a cancel button 178.

The registered name input field 172, the terminal ID input field 174, and the transmission destination information input field 175 are fields into which a name of a user of a terminal device to be registered, a terminal ID of the terminal device, and transmission destination information of the terminal device are input, respectively. The register button 177 is a button for confirming registration of the information input into the input fields. The cancel button 178 is a button for canceling registration of the input information.

The user points the cursor to the input fields using cursor keys, and inputs a registered name, a terminal ID, and transmission destination information into a corresponding input field. After inputting the information, the user points the cursor to the register button 177, and presses the determine button. Note that herein after such an operation to point the cursor to a button being displayed on the display screen and press the determine button included in the input unit 106 is expressed as just “to press a button”. Also, if the user hopes to cancel the registration, the user presses the cancel button 178.

Upon receiving operation instruction information indicating the press of the register button 177 via the input unit 106, the other-terminal information setting unit 151 generates a piece of other-terminal information including the registered name, the terminal ID, and the transmission destination information that have been input into the input fields and the prestored entity evaluation value “0”. The other-terminal information setting unit 151 adds the generated piece of other-terminal information to the other-terminal information table 131.

(7-3) Content Information Setting Unit 153

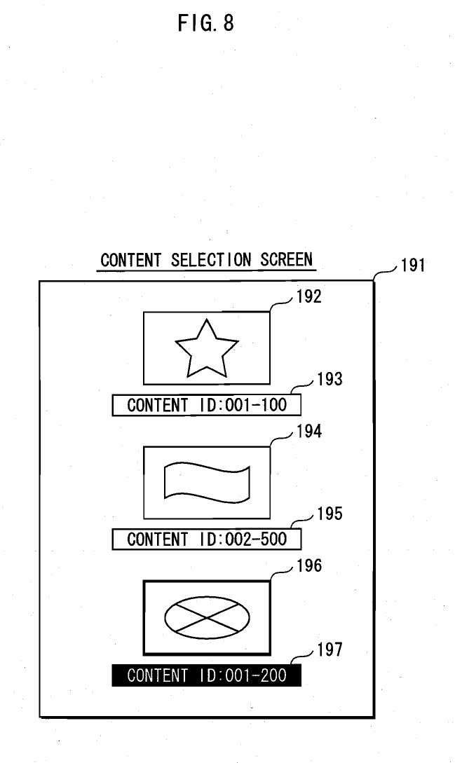

The content information setting unit 153 receives operation instruction information indicating content information from the input unit 106. Upon receiving the operation instruction information, based on the screen data stored in the storage unit 110, the pieces of content data, and the content IDs, the content information setting unit 153 generates a content selection screen displaying the pieces of content data in thumbnail form, and displays the generated content selection screen on the display unit 109. FIG. 8 shows an example of the content selection screen displayed here. A content selection screen 191 includes pieces of content data 192, 194, and 196, and content IDs 193, 195, and 197. Although only three pieces of content data are displayed here, other pieces of content data can be displayed by the user scrolling the screen using the direction keys.

The pieces of content data 192, 194, and 196 respectively correspond to the content IDs 193, 195, and 197. The user operates the direction keys to point the cursor to a desired piece of content data, and presses the determine button included in the input unit 106 to select the desired piece of content data.

Upon receiving the selection of the piece of content data via the input unit 106, the content information setting unit 153 generates a content information setting screen based on the screen data stored in the storage unit 110 and the selected piece of content data, and displays the generated content information setting screen on the display unit 109.

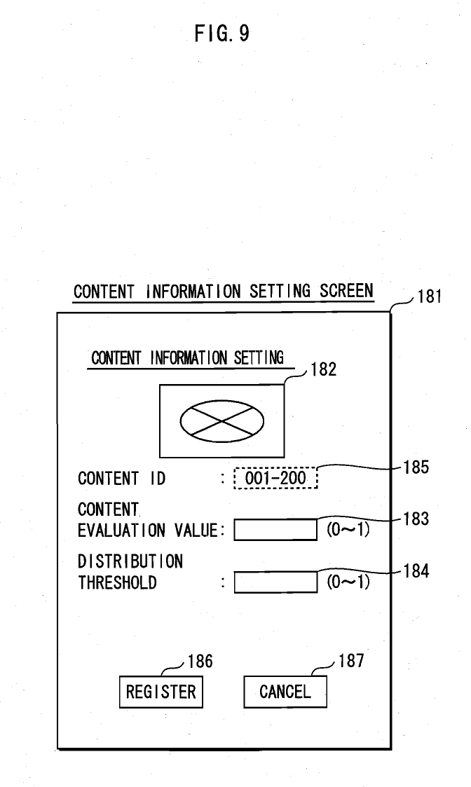

FIG. 9 shows an example of the content information setting screen displayed here. As shown in FIG. 9, the content information setting screen 181 displays content data 182, a content ID 185, a content evaluation value input field 183, a distribution threshold input field 184, a register button 186, and a cancel button 187.

The content data 182 is a piece of content data selected by the user on the content selection screen 191. The content ID 185 corresponds to the content data 182. The content evaluation value input field 183 is a field into which a content evaluation value is input by the user. The distribution threshold input field 184 is a field into which a distribution threshold is input by the user. The register button 186 is a button for determining to register the content evaluation value and the distribution threshold that have been respectively input into the content evaluation value input field 183 and the distribution threshold input field 184. The cancel button 187 is a button determining to cancel the content information setting processing.

The user operates the ten key, the direction keys, and the like to input numeric values from 0 to 1 into the content evaluation value input field 183 and the distribution threshold input field 184. Then, the user presses the register button 186.

Upon detecting the press of the register button 186 via the input unit 106, the content information setting unit 153 selects, from the distribution condition table 141, a distribution condition corresponding to the selected piece of content data, and updates a distribution threshold included in the selected distribution condition to the numeric value input into the distribution threshold input field 184.

Next, the content information setting unit 153 selects a piece of content evaluation value information corresponding to the selected piece of content data from the content evaluation value table 145 stored in the storage unit 110, and updates a content evaluation value included in the selected piece of content-evaluation value information to the numeric value input into the content evaluation value input field 183.

Note that, if top three digits of a content ID indicating the piece of content data selected by the user do not match the terminal ID 122 “001”, that is, if apiece of content data received from another terminal device is selected, the content information setting unit 153 generates a content information setting screen, which is almost the same as the content information setting screen 181 shown in FIG. 9 but that does not include the distribution threshold input field 184. The user inputs only a content evaluation value into the generated content information setting screen. In this case, the content information setting unit 153 updates only the content evaluation value included in the content evaluation value table 145.

(7-4) Transmission Content Selection Unit 154

The transmission content selection unit 154 prestores therein a distribution threshold “+99” indicating that transmission of content data is prohibited and a distribution threshold “−99” indicating that no distribution threshold is set.

The transmission content selection unit 154 receives operation instruction information for instructing to transmit a piece of content data via the input unit 106. Upon receiving the operation instruction information, the transmission content selection unit 154 generates a content selection screen using the screen data stored in the storage unit 110 and pieces of content data, and displays the generated content selection screen on the display unit 109. The content selection screen displayed here is the same as the content selection screen 191 shown in FIG. 8. Therefore, an explanation thereof is omitted.

Then, the transmission content selection unit 154 receives the user's selection of a piece of content data via the input unit 106. Next, the transmission content selection unit 154 detects a distribution condition corresponding to the selected piece of content data from the distribution condition table 141, and reads a distribution threshold included in the detected distribution condition. The transmission content selection unit 154 compares the read distribution threshold with each of the prestored distribution thresholds “+99” and “−99”. If the read distribution threshold matches “+99”, the transmission content selection unit 154 generates an error screen for notifying that transmission of the selected piece of content data is prohibited, and displays the generated error screen on the display unit 109. Note that although the user is notified of prohibition of the content data transmission via the display of the error screen here, the notification method is not limited to this. Alternatively, output of a sound indicating the error may be employed, for example.

If the read distribution threshold matches “−99”, the transmission content selection unit 154 generates an error screen for notifying that transmission of the selected piece of content data is permitted only after a corresponding distribution threshold has been set, and displays the generated error screen on the display unit 109.

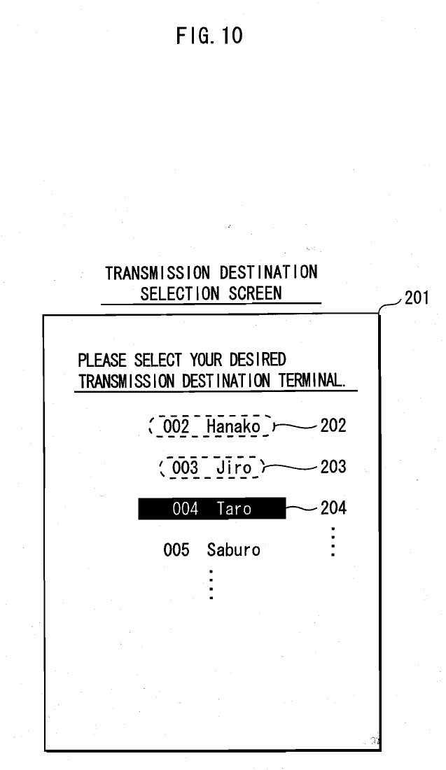

If the read distribution threshold does not match “±99”, the transmission content selection unit 154 reads terminal IDs and registered names included in the pieces of other-terminal information constituting the other-terminal information table 131 stored in the storage unit 110. The transmission content selection unit 154 generates a transmission destination selection screen that displays a list of the read terminal IDs and registered names, and displays the generated transmission destination selection screen on the display unit 109. FIG. 10 shows an example of the transmission destination selection screen displayed here. A transmission destination selection screen 201 displays, as shown in FIG. 10, transmission destination candidates 202, 203, 204, . . . , each of which including a terminal ID and a registered name. The transmission destination candidates respectively correspond to the pieces of other-terminal information 132, 133, 134, . . . , that constitute the other-terminal information table 131. For example, the transmission destination candidate 202 corresponds to the other-terminal information 132, and both include the same terminal ID and registered name.

The user operates the direction keys to point the cursor to a transmission destination candidate indicating a desired transmission destination, and presses the determine button to select a terminal device that is to be a transmission destination (herein after referred to as a “transmission destination terminal”). In FIG. 10, the cursor is pointed to the transmission destination candidate 204 including a terminal ID “004” and a registered name “Taro”.

Upon receiving the selection of the transmission destination terminal via the input unit 106, the transmission content selection unit 154 reads an entity evaluation value from apiece of other-terminal information corresponding to the selected transmission destination terminal.

Next, the transmission content selection unit 154 reads the terminal ID 122 “001” from the storage unit 110, and compares the read terminal ID 122 “001” with top three digits of a content ID corresponding to the selected piece of content data. If the terminal ID 122 “001” does not match the top three digits of the content ID, that is, if the selected piece of content data is a piece of content data received from another terminal device, the transmission content selection unit 154 compares the read distribution threshold with the read entity evaluation value.

If the entity evaluation value is less than the distribution threshold, the transmission content selection unit 154 generates an error screen for notifying that transmission of the selected piece of content data to the selected transmission destination terminal is prohibited, and displays the generated error screen on the display unit 109.

If the entity threshold is no less than the distribution threshold, the transmission content selection unit 154 outputs, to the transmission processing unit 157, the content ID indicating the selected piece of content data and a terminal ID indicating the transmission destination terminal.

If the top three digits of the content ID indicating the selected piece of content data matches the terminal ID 122 “001”, that is, if the selected piece of content data is a piece of content data acquired by the terminal device 100A from the memory card 111, the transmission content selection unit 154 likewise outputs the content ID and the terminal ID to the transmission processing unit 157.

(7-5) Transmission Processing Unit 157

The transmission processing unit 157 is a functional unit that generates a secondary distribution threshold, and transmits the generated secondary distribution threshold together with a piece of content data. The secondary distribution threshold indicates a condition for secondary distribution by a transmission destination terminal of the piece of content data. In the transmission destination terminal, the secondary distribution threshold is used as a distribution threshold. The secondary distribution threshold is a decimal number from 0 to 1.0 or +99. A secondary distribution threshold “+99” indicates unconditional prohibition for secondary distribution. A secondary distribution threshold from “0” to “1.0” indicates permission for secondary distribution to only a terminal device whose entity evaluation value is no less than the secondary distribution threshold.

The transmission processing unit 157 stores therein “1.0” that is the maximum value of secondary distribution thresholds indicating permission for secondary distribution and “+99” that is the secondary distribution threshold indicating prohibition for secondary distribution.

The transmission processing unit 157 receives, from the transmission content selection unit 154, a content ID indicating apiece of content data selected by the user and a terminal ID indicating a transmission destination terminal selected by the user. Upon receiving the content ID and the terminal ID, the transmission processing unit 157 selects a distribution condition including the received content ID from the distribution condition table 141 stored in the storage unit 110, and reads a distribution threshold included in the selected distribution condition.

Next, the transmission processing unit 157 selects a piece of other-terminal information including the received terminal ID from the other-terminal information table 131 stored in the storage unit 110, and reads an entity evaluation value included in the selected piece of other-terminal information.

The transmission processing unit 157 divides the read distribution threshold by the entity evaluation value to generate a secondary distribution threshold. The figures no more than the second decimal place are rounded down. Here, the transmission processing unit 157 compares the calculation result with the prestored maximum value of the secondary distribution thresholds “1.0” indicating permission for secondary distribution. If the calculation result is greater than “1.0”, the transmission processing unit 157 determines the prestored “+99” as a secondary distribution threshold, regardless of the calculation result.

After generating the secondary distribution threshold, the transmission processing unit 157 reads the piece of content data corresponding to the received content ID from the storage unit 110, and then reads the piece of transmission destination information corresponding to the received terminal ID from the other-terminal information table 131. The transmission processing unit 157 transmits the content ID, the read piece of content data, and the generated secondary distribution threshold to a transmission destination indicated by the read piece of transmission destination information via the transmission/reception unit 102 and the antenna 101.

After completing the transmission, the transmission processing unit 157 outputs, to the entity evaluation value derivation unit 156, the content ID and the terminal ID that have been received from the transmission content selection unit 154.

(7-6) Entity Evaluation Value Derivation Unit 156

Each time a piece of content data is transmitted, the entity evaluation value derivation unit 156 judges whether updating of an entity evaluation value corresponding to a terminal device that is a transmission destination is necessary. If the updating is necessary, the entity evaluation value derivation unit 156 resets the entity evaluation value. The following describes in detail the entity evaluation value derivation unit 156.

The entity evaluation value derivation unit 156 receives, from the transmission processing unit 157, a content ID indicating a piece of content data selected by the user and a terminal ID indicating a transmission destination terminal selected by the user. Upon receiving the content ID and the terminal ID, the entity evaluation value derivation unit 156 selects apiece of content evaluation value information including the received content ID from the content evaluation value table 145 stored in the storage unit 110, and reads a content evaluation value included in the selected piece of content evaluation value information.

Next, the entity evaluation value derivation unit 156 selects a piece of other-terminal information including the received terminal ID from the other-terminal information table 131 stored in the storage unit 110, and reads an entity evaluation value included in the selected piece of other-terminal information.

Next, the entity evaluation value derivation unit 156 compares the read content evaluation value with the read entity evaluation value. If the content evaluation value is greater than the entity evaluation value, the entity evaluation value derivation unit 156 replaces the entity evaluation value included in the selected piece of other-terminal information with the read content evaluation value.

If the read content evaluation value is no more than the entity evaluation value, the entity evaluation value derivation unit 156 does not the above update processing.

(7-7) Reception Processing Unit 158

The reception processing unit 158 is a functional unit that receives and saves content data transmitted from other terminal devices. The following describes in detail the reception processing unit 158.

The reception processing unit 158 prestores therein “0”, which is an initial value of the content evaluation value.

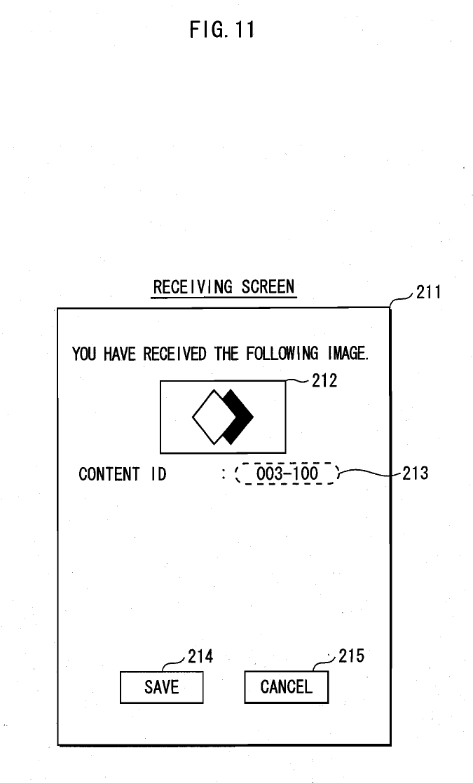

The reception processing unit 158 receives a piece of content data, a content ID, and a secondary distribution threshold from another terminal device via the antenna 101 and the transmission/reception unit 102. Upon receiving the piece of content data, the content ID, and the secondary distribution threshold, the reception processing unit 158 generates a content receiving screen for notifying of reception of the piece of content data using the screen data stored in the storage unit 110, the received piece of content data and content ID, and displays the generated content receiving screen on the display unit 109. FIG. 11 shows an example of the receiving screen displayed here. The receiving screen 211 displays, as shown in FIG. 11, content data 212 and a content ID 213 that have been received, a save button 214, and a cancel button 215. The user operates the direction keys and the like to press any one of the save button 214 and the cancel button 215 being displayed.

Upon detecting the press of the save button 214 via the input unit 106, the reception processing unit 158 writes the received piece of content data and content ID into the storage unit 110. Next, the reception processing unit 158 generates a new distribution condition including the received content ID, and adds the generated distribution condition to the distribution condition table 141. The new distribution condition generated here includes the received secondary distribution threshold as a distribution threshold.

Next, the reception processing unit 158 generates a new piece of content evaluation value information including the received content ID and the stored initial value “0” of the stored content evaluation value, and adds the generated piece of content evaluation value information to the content evaluation value table 145.

A specific description of the reception processing unit 158 is given using an example of a case where the content data 212 shown in FIG. 11 is received. Assume that the reception processing unit 158 receives a secondary distribution threshold “0.7” together with a piece of content data and a content ID “003-100”. The reception processing unit 158 generates the receiving screen 211 based on the screen data stored in the storage unit 110 and the received piece of content data and content ID, and displays the generated receiving screen 211 on the display unit 109. Upon detecting press of the save button 214, the reception processing unit 158 generates a distribution condition 143 including the content ID “003-100” and the secondary distribution threshold “0.7” (see FIG. 5), and adds the generated distribution condition 143 to the distribution condition table 141. Then, the reception processing unit 158 generates content evaluation value information 147 including the content ID “003-100” and the content evaluation value “0” (see FIG. 6), and adds the generated content evaluation value information 147 to the content evaluation value table 145.

### 1.3 Operations

The following describes operations of the terminal device 100A with reference to the drawings.

(1) Operations of Terminal Device 100A

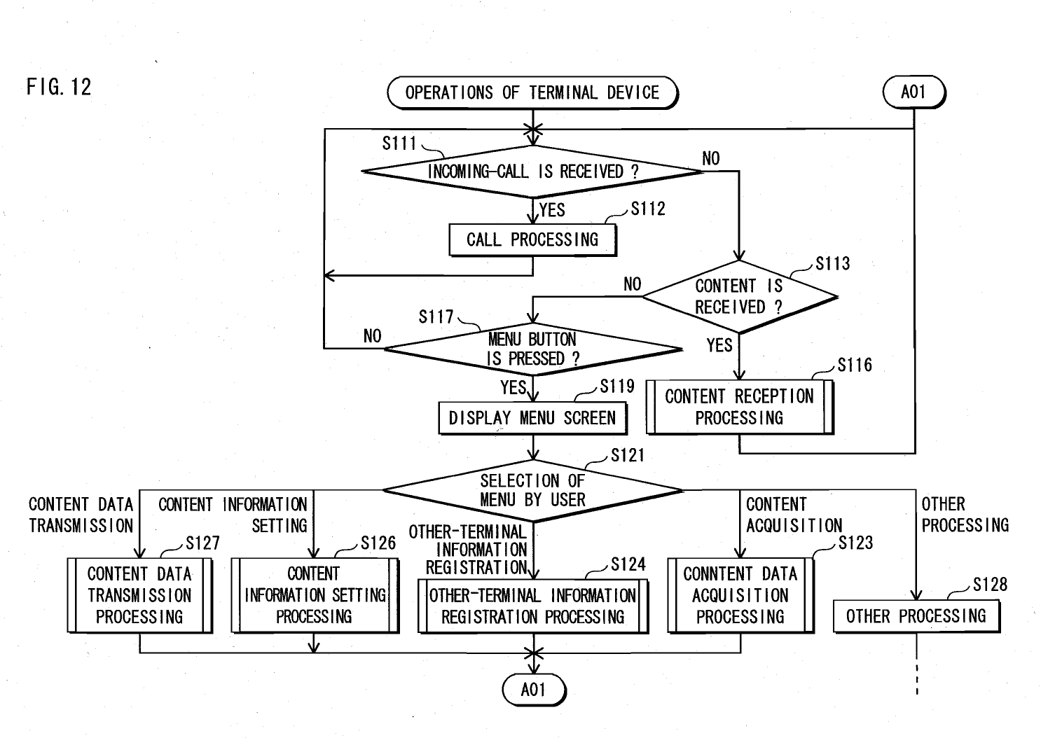

FIG. 12 is a flow chart showing the operations of the terminal device 100A. The following describes the operations of the terminal device 100A with reference to FIG. 12. Note that the explanation starts with Step S111 for convenience.

The terminal device 100A in the normal standby mode is waiting until any one of an incoming-call, reception of content data, and the user's press of a menu button has been detected (Steps S111, S113, and S117: NO).

If an incoming-call is detected (Step S111: YES), the call processing unit 104 performs call processing between the terminal device 100A and an external terminal device via the antenna 101 and the transmission/reception unit 102 (Step S112).

If content data is received via the antenna 101 and the transmission/reception unit 102 (Step S113: YES), the reception processing unit 158 performs content reception processing (Step S116).

Also, if operation instruction information indicating press of the menu button is received via the input unit 106 (Step S117: YES), the control unit 107 reads, from the storage unit 110, the menu screen having displayed thereon the functions of the terminal device 100A such as content acquisition and other-terminal information registration. The control unit 107 displays the read menu screen on the display unit 109 (Step S119). Then, the control unit 107 receives the user's selection of a menu via the input unit 106 (Step S121).

If receiving an instruction to acquire content data by the user's operation (Step S121: “content acquisition”), the content acquisition unit 152 performs content data acquisition processing (Step S123).

If receiving an instruction to register other-terminal information by the user's operation (Step S121: “other-terminal information registration”), the other-terminal information setting unit 151 performs other-terminal information registration processing (Step S124).

If receiving an instruction to set content information (Step S121: “content information setting”), the content information setting unit 153 performs content information setting processing (Step S126).

If receiving an instruction to transmit content data (Step S121: “content data transmission”), the transmission content selection unit 154 starts content data transmission processing (Step S127).

Also, if receiving an instruction to perform other processing (Step S121: “other processing”), the control unit 107 performs other processing (Step S128).

After the processing in Steps S123, S124, S126, S127, and S128 ends, the flow returns to Step S111.

(2) Content Data Acquisition Processing

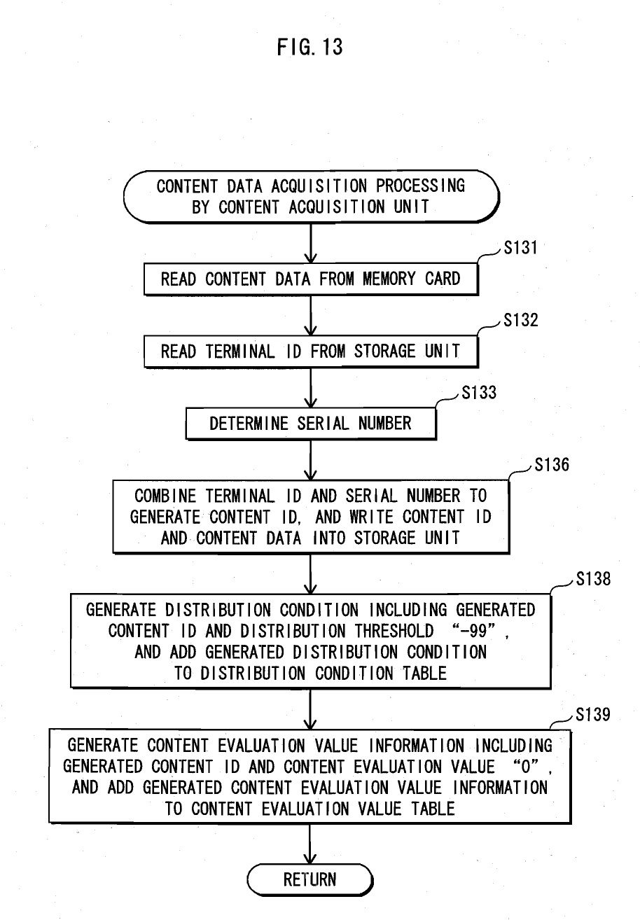

FIG. 13 is a flow chart showing the content data acquisition processing. The following describes the content data acquisition processing with reference to FIG. 13. Here, FIG. 13 shows the details of Step S123 in FIG. 12.

The content acquisition unit 152 reads content data from the memory card 111 (Step S131). Next, the content acquisition unit 152 reads the terminal ID 122 “001” from the storage unit 110 (Step S132), and then determines a three-digit serial number using the counter (Step S133). The content acquisition unit 152 combines the read terminal ID 122 “001” and the serial number to generate a content ID corresponding to the read content data. The content acquisition unit 152 writes the generated content ID and the read content data into the storage unit 110 in correspondence with each other (Step S136).

Next, the content acquisition unit 152 generates a distribution condition including the generated content ID and the distribution threshold “−99”, and adds the generated distribution condition to the distribution condition table 141 (Step S138). Next, the content acquisition unit 152 generates a piece of content evaluation value information including the generated content ID and the content evaluation value “0”, and adds the generated piece of content evaluation value information to the content evaluation value table 145 (Step S139).

(3) Other-Terminal Information Registration Processing

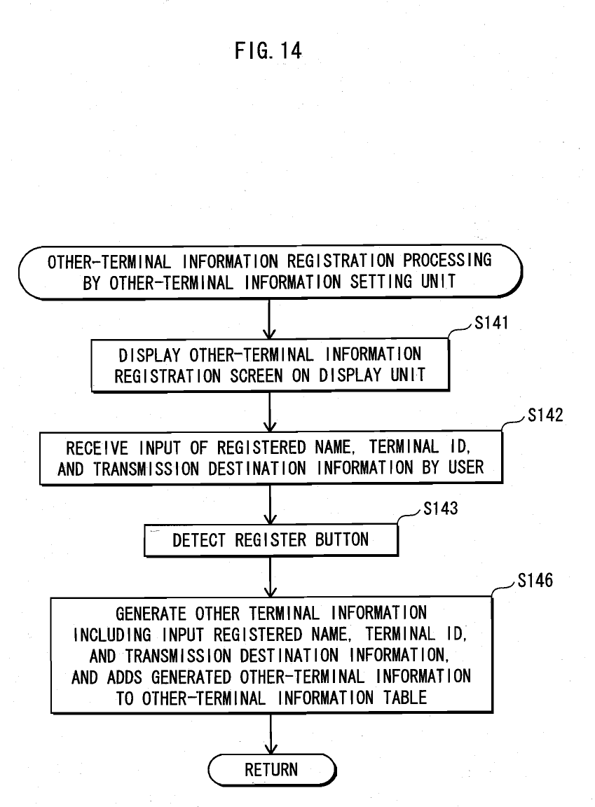

FIG. 14 is a flow chart showing the other-terminal information registration processing. The following describes the other-terminal information registration processing performed by the other-terminal information setting unit 151. Note that FIG. 14 shows the details of Step S124 in FIG. 12.

The other-terminal information setting unit 151 generates the other-terminal information registration screen 171 based on the screen data stored in the storage unit 110, and displays the generated other-terminal information registration screen 171 on the display unit 109 (Step S141). Next, the other-terminal information setting unit 151 receives the user's input of a registered name, a terminal ID, and a piece of transmission destination information via the input unit 106 (Step S142). Then, upon detecting press of the register button 186 (Step S143), the other-terminal information setting unit 151 newly generates a piece of other-terminal information including the registered name, the terminal ID, and the piece of transmission destination information that have been input, and adds the generated piece of other-terminal information to the other-terminal information table 131 (Step S146).

(4) Content Information Setting Processing

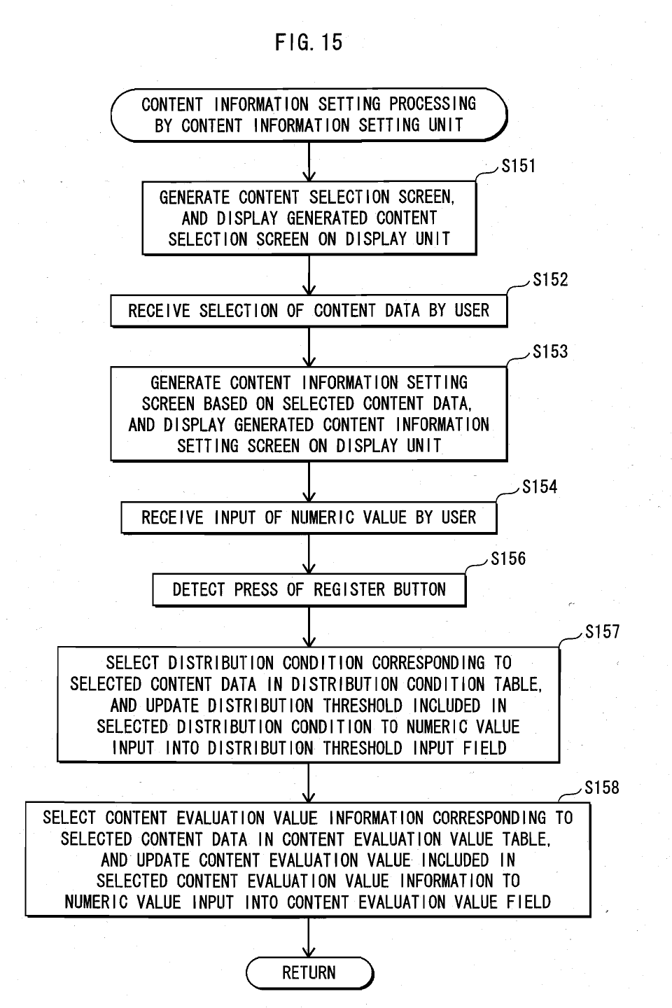

FIG. 15 is a flow chart showing the content information setting processing. The following describes the content information setting processing performed by the content information setting unit 153, with reference to FIG. 15. Here, FIG. 15 shows the details of Step S126 in FIG. 12.

The content information setting unit 153 generates the content selection screen 191, and displays the generated content selection screen 191 on the display unit 109 (Step S151).

Next, the content information setting unit 153 receives the user's selection of a piece of content data via the input unit 106 (Step S152). Then, the content information setting unit 153 generates the content information setting screen 181 using the selected piece of content data, and displays the generated content information setting screen 181 on the display unit 109 (Step S153). Note that if top three digits of a content ID corresponding to the selected piece of content data do not match the terminal ID 122 “001”, the content information setting unit 153 generates a content information setting screen not including a distribution threshold input filed, and displays the generated content information setting screen 181 on the display unit 109.

Next, the content information setting unit 153 receives the user's input of numeric values into the content evaluation value input field 183 and the distribution threshold input field 184 via the input unit 106 (Step S154). Upon detecting press of the register button 186 (Step S156), the content information setting unit 153 selects a distribution condition corresponding to the selected piece of content data from the distribution condition table 141, and updates a distribution threshold included in the selected distribution condition to the numeric value input into the distribution threshold input field 184 (Step S157).

Then, the content information setting unit 153 selects a piece of content evaluation value information corresponding to the selected piece of content data from the content evaluation value table 145, and updates a content evaluation value included in the piece of selected content evaluation value information to the numeric value input into the content evaluation value field 183 (Step S158).

(5) Content Data Transmission Processing

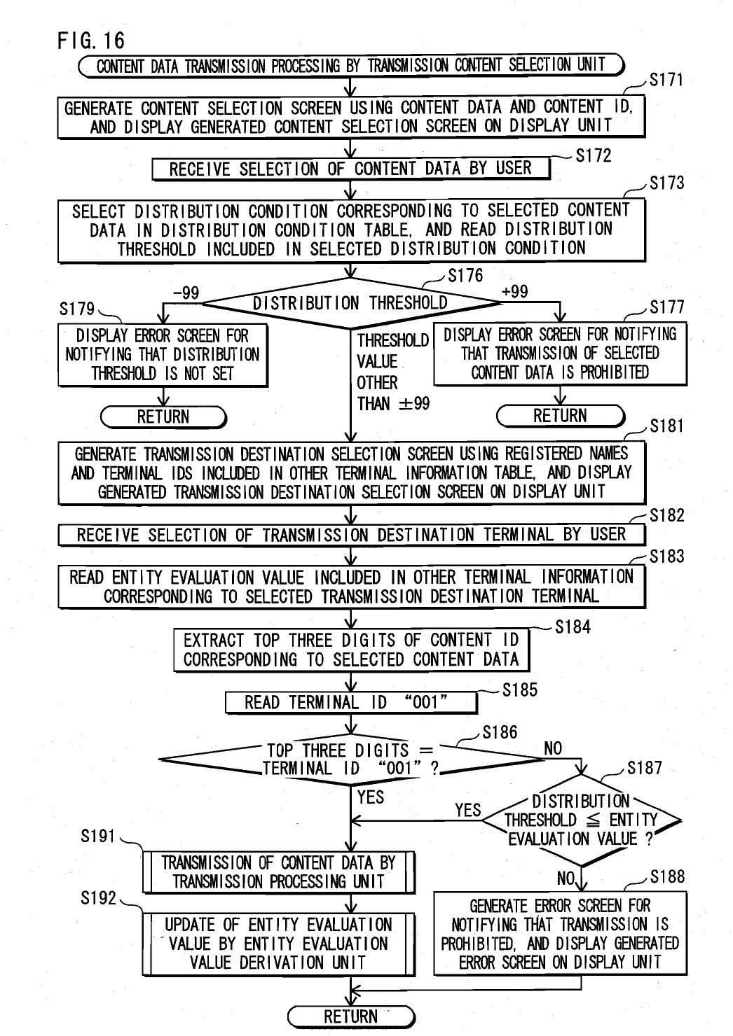

FIG. 16 is a flow chart showing the content data transmission processing. The following describes the content data transmission processing in the terminal device 100A, with reference to FIG. 16. Note that FIG. 16 shows the details of Step S127 in FIG. 12.

The transmission content selection unit 154 generates the content selection screen 191 based on pieces of content data and content IDs stored in the storage unit 110. The display unit 109 displays the generated content selection screen 191 (Step S171).

Next, the transmission content selection unit 154 receives the user's selection of one of the pieces of content data via the input unit 106 (Step S172). The transmission content selection unit 154 selects a distribution condition corresponding to the selected piece of content data from the distribution condition table 141, and reads a distribution threshold included in the selected distribution condition (Step S173).

If the read distribution threshold is “+99” (Step S176: “+99”), the transmission content selection unit 154 generates an error screen for notifying that transmission of the selected piece of content data is prohibited, and the display unit 109 displays the generated error screen (Step S177).

If the read distribution threshold is “−99” (Step S176: “−99”), the transmission content selection unit 154 generates an error screen for notifying that transmission of the selected piece of content data is prohibited because no distribution threshold is set. Then, the display unit 109 displays the generated error screen (Step S179).

If the read distribution threshold is a value other than “±99” (Step S176: value other than “±99”), the transmission content selection unit 154 generates the transmission destination selection screen 201 using registered names and terminal IDs included in the pieces of other-terminal information in the other-terminal information table 131. The display unit 109 displays the generated transmission destination selection screen 201 (Step S181). Next, the transmission content selection unit 154 receives the user's selection of a transmission destination terminal (Step S182), and reads an entity evaluation value included in a piece of other-terminal information corresponding to the selected transmission destination terminal (Step S183).

Moreover, the transmission content selection unit 154 extracts top three digits of a content ID corresponding to the piece of content data selected by the user (Step S184). Next, the transmission content selection unit 154 reads the terminal ID 122 “001” identifying the terminal device 100A from the storage unit 110 (Step S185). The transmission content selection unit 154 compares the read terminal ID 122 “001” with the extracted top three digits (Step S186). If the read terminal ID 122 “001” does not match the extracted top three digits (Step S186: NO), the transmission content selection unit 154 compares the read distribution threshold with the entity evaluation value (Step S187). If the entity evaluation value is no less than the distribution threshold (Step S187: YES), the transmission content selection unit 154 outputs, to the transmission processing unit 157, the content ID identifying the selected piece of content data and the terminal ID identifying the transmission destination terminal. Then, the flow proceeds to Step S191.

If the entity evaluation value is less than the distribution threshold (Step S187: NO), the transmission content selection unit 154 generates an error screen for notifying that transmission of the selected piece of content data to the selected transmission destination terminal is prohibited. The display unit 109 displays the generated error screen (Step S188).

In Step S186, if the extracted top three digits match the read terminal ID 122 “001” (Step S186: YES), the transmission content selection unit 154 outputs, to the transmission processing unit 157, the content ID identifying the piece of content data selected by the user and the terminal ID identifying the transmission destination terminal.

The transmission processing unit 157 receives the content ID and the terminal ID from the transmission content selection unit 154. Upon receiving the content ID and the terminal ID, the transmission processing unit 157 transmits the piece of content data identified by the content ID (Step S191). After transmitting the piece of content data, the transmission processing unit 157 outputs, to the entity evaluation value derivation unit 156, the terminal ID and the content ID that have been received from the transmission content selection unit 154.

The entity evaluation value derivation unit 156 receives the content ID and the terminal ID from the transmission processing unit 157, and updates the entity evaluation value corresponding to the terminal device identified by the received terminal ID (Step S192).

(6) Transmission Processing Performed by Transmission Processing Unit 157

The transmission processing unit 157 receives, from the transmission content selection unit 154, a content ID identifying a piece of content data selected by the user and a terminal ID identifying a transmission destination terminal. Upon receiving the content ID and the terminal ID, the transmission processing unit 157 performs transmission processing of the selected piece of content data.

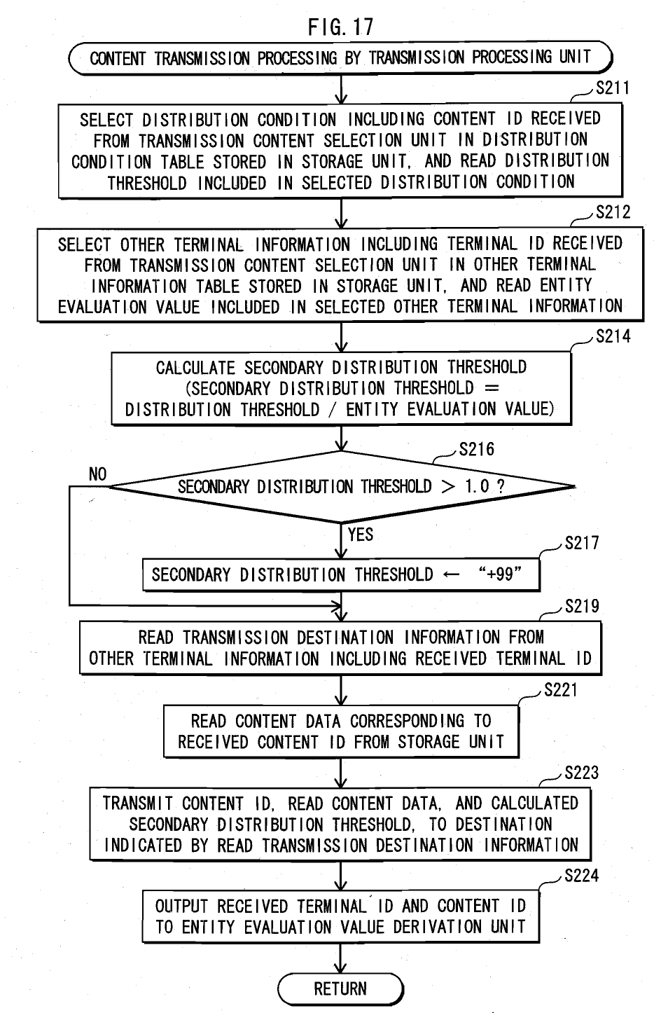

FIG. 17 is a flow chart showing the transmission processing performed by the transmission processing unit 157. The following describes the transmission processing with reference to FIG. 17. Here, FIG. 17 shows the details of Step S191 in FIG. 16.

The transmission processing unit 157 receives, from the transmission content selection unit 154, a content ID identifying a piece of content data selected by the user and a terminal ID identifying a transmission destination terminal. Upon receiving the content ID and the terminal ID, the transmission processing unit 157 selects a distribution condition including the received content ID from the distribution condition table 141 stored in the storage unit 110, and reads a distribution threshold included in the selected distribution condition (Step S211).

Next, the transmission processing unit 157 selects a piece of other-terminal information including the received terminal ID from the other-terminal information table 131 stored in the storage unit 110, and reads an entity evaluation value included in the selected piece of other-terminal information (Step S212).

Next, the transmission processing unit 157 calculates a secondary distribution threshold using the read distribution threshold and entity evaluation value in accordance with the following formula (Step S214).

Secondary distribution threshold=distribution threshold/entity evaluation value (equation)

Here, if a calculated secondary distribution threshold is greater than 1.0 (Step S216: YES), the transmission processing unit 157 determines “+99” as the secondary distribution threshold, instead of the calculation result. If the calculated secondary distribution threshold is no more than 1.0 (Step S216: NO), the transmission processing unit 157 does not perform Step S217.

Then, the transmission processing unit 157 reads a piece of transmission destination information from the piece of other-terminal information including the received terminal ID (Step S219), and reads a piece of content data corresponding to the received content ID from the storage unit 110 (Step S221). The transmission processing unit 157 transmits the content ID, the read piece of content data, and the calculated secondary distribution threshold, to a transmission destination indicated by the read piece of transmission destination information (Step S223).

After transmitting the content ID and so on, the transmission processing unit 157 outputs, to the entity evaluation value derivation unit 156, the terminal ID and the content ID that have been received from the transmission content selection unit 154 (Step S224).

(7) Entity Evaluation Value Update Processing

The entity evaluation value derivation unit 156 receives, from the transmission processing unit 157, the content ID identifying the piece of content data selected by the user and the terminal ID identifying the transmission destination terminal selected by the user. Upon receiving the content ID and the terminal ID, the entity evaluation value derivation unit 156 performs update processing of an entity evaluation value corresponding to the terminal device identified by the received terminal ID.

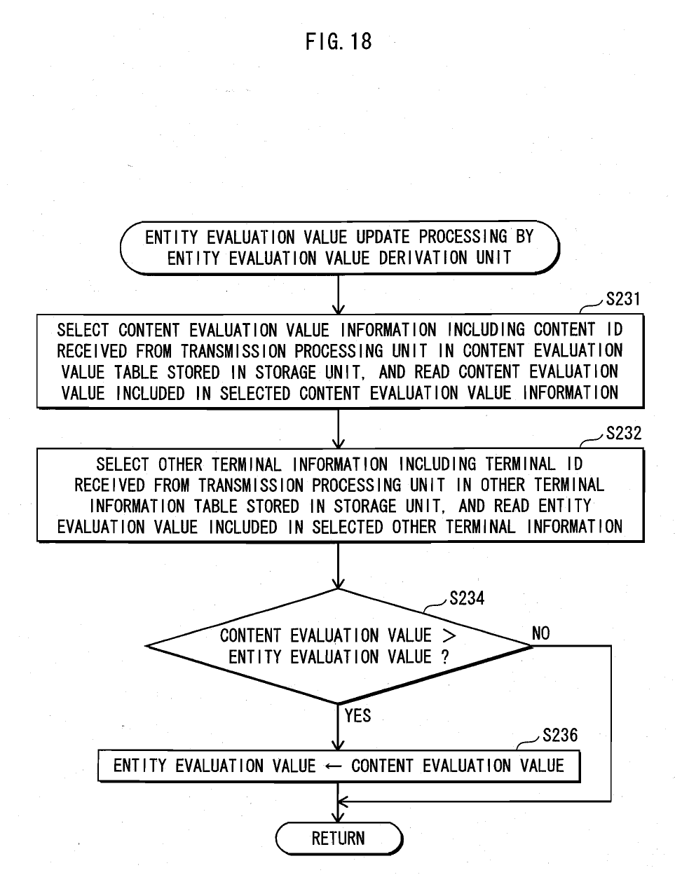

FIG. 18 is a flow chart showing the entity evaluation value update processing performed by the entity evaluation value derivation unit 156. The following describes the entity evaluation value update processing with reference to FIG. 18. Note that FIG. 18 shows the details of Step S192 in FIG. 16.

The entity evaluation value derivation unit 156 selects apiece of content evaluation value information including the received content ID from the content evaluation value table 145 stored in the storage unit 110, and reads a content evaluation value included in the selected piece of content evaluation value information (Step S231). Next, the entity evaluation value derivation unit 156 selects a piece of other-terminal information including the received terminal ID from the other-terminal information table 131 stored in the storage unit 110, and reads an entity evaluation value included in the selected piece of other-terminal information (Step S232).

The entity evaluation value derivation unit 156 compares the read content evaluation value with the read entity evaluation value (Step S234). If the content evaluation value is no more than the entity evaluation value (Step S234: NO), the entity evaluation value derivation unit 156 terminates the entity evaluation value update processing.

If the content evaluation value is greater than the entity evaluation value (Step S234: YES), the entity evaluation value derivation unit 156 replaces the entity evaluation value included in the selected piece of other-terminal information with the read content evaluation value (Step S236).

(8) Content Reception Processing

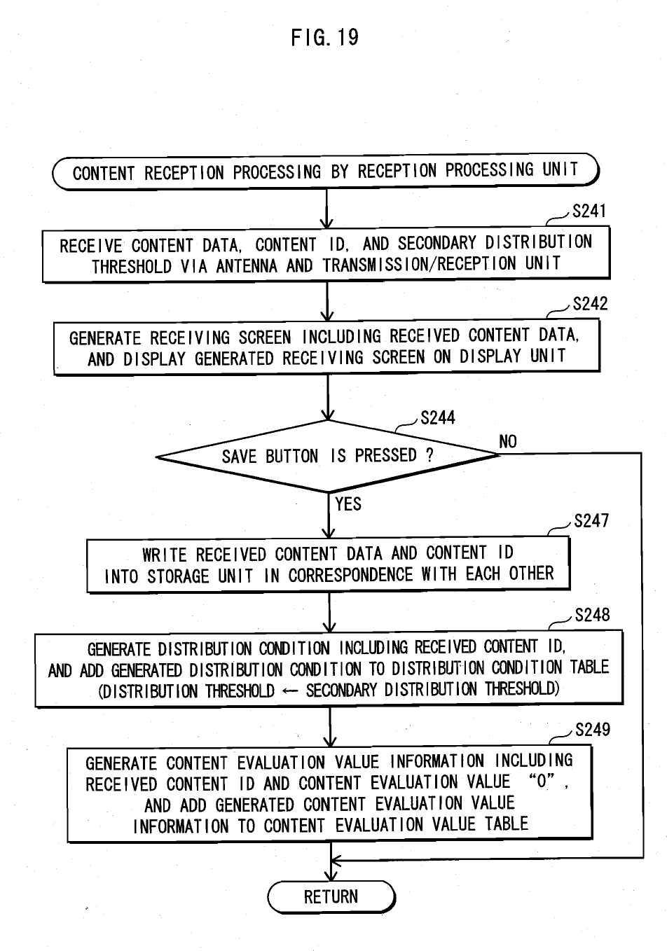

FIG. 19 is a flowchart showing the content reception processing. The following describes the content reception processing with reference to FIG. 19. Note that FIG. 19 shows the details of Step S116 in FIG. 12.

The reception processing unit 158 receives a content ID, a piece of content data, and a secondary distribution threshold via the antenna 101 and the transmission/reception unit 102 (Step S241). Upon receiving the content ID and so on, the reception processing unit 158 generates the receiving screen 211 including the received piece of content data, and displays the receiving screen 211 on the display unit 109 (Step S242).

If the save button 214 displayed on the receiving screen 211 is pressed by the user's operation (Step S244: YES), the reception processing unit 158 writes the received content ID and the received piece of content data into the storage unit 110 in correspondence with each other (Step S247). In Step S244, if the save button 214 is not pressed (Step S244: NO), the reception processing unit 158 deletes the received content ID, piece of content data, and secondary distribution threshold, and terminates the reception processing.

After writing the piece of content data, the reception processing unit 158 generates a distribution condition including the received content ID, and adds the generated distribution condition to the distribution condition table 141 (Step S248). The distribution condition generated here includes the received secondary distribution threshold as a distribution threshold.

Then, the reception processing unit 158 generates a new piece of content evaluation value information including the received content ID and an initial value “0” of the content evaluation value, and adds the generated piece of content evaluation value information to the content evaluation value table 145 (Step S249).

### 1.4 Conclusion and Effects

As described above, the terminal device 100A according to the first embodiment stores therein content evaluation values respectively corresponding to pieces of content data, which are set by the user of the terminal device 100A.

Moreover, the terminal device 100A stores therein pieces of other-terminal information input by the user, each of which includes a registered name and a piece of transmission destination information that correspond to a different terminal device. When a piece of content data is transmitted by the user's operation, the terminal device 100A replaces an entity evaluation value of a terminal device that is a transmission destination with a content evaluation value corresponding to the transmitted piece of content data.

Specifically, the terminal device 100A compares the entity evaluation value that has been determined before the piece of data is transmitted with the content evaluation value corresponding to the transmitted piece of content data. If the content evaluation value is greater than the entity evaluation value, the terminal device 100A replaces the entity evaluation value of the terminal device that is the transmission destination with the content evaluation value. Since the terminal device 100A updates an entity evaluation value of another terminal device each time the terminal device 100A transmits a piece of content data. As a result, the higher a content evaluation value corresponding to the piece of content data that has ever been transmitted to the another terminal device is, the higher the entity evaluation value is.

With such a structure, although the user subjectively determines a content evaluation value corresponding to a piece of content, the user determines an entity evaluation value of a terminal device based on the determined content evaluation value as a uniform criterion. Therefore, the structure exhibits an excellent effect that variation in criteria for entity evaluation values of terminal devices stored in the storage unit 110 can be corrected.

### 2. Second Embodiment

The following describes a second embodiment of the present invention with reference to the drawings.

### 2.1 Outline of Information Distribution System

Like the information distribution system according to the first embodiment, an information distribution system according to the second embodiment includes many terminal devices, and is a system in which transmission/reception of content data is performed among terminal devices. A terminal device that transmits content data determines whether transmission of the content data is permitted in accordance with an entity evaluation value of a terminal device that is a transmission destination and a distribution threshold of the content data that is a transmission target. However, the second embodiment differs from the first embodiment in method for determining entity evaluation values.

Each of the terminal devices according to the second embodiment further transmits/receives personal information relating to a user thereof, such as the user's name, address, and phone number (herein after, such personal information is referred to as a “profile”).

When transmitting content data, the terminal device 100A according to the first embodiment determines an entity evaluation value of a terminal device that is a transmission destination using a content evaluation value of the transmitted content data. The terminal device 300 included in the information distribution system according to the second embodiment determines an entity evaluation value of another terminal device in accordance with a profile type and the number of profiles acquired from the another terminal device, instead of updating the entity evaluation value using the content evaluation value of transmitted content data.

Like the information distribution system according to the first embodiment, the information distribution system according to the second embodiment includes many terminal devices. Both of the information distribution systems include the same structure and functions. Accordingly, only the terminal device 300 is described below.

### 2.2 Structure of Terminal Device 300

The terminal device 300 is a terminal device that transmits/receives data, and is also an evaluation device that generates entity evaluation values for controlling data distribution.

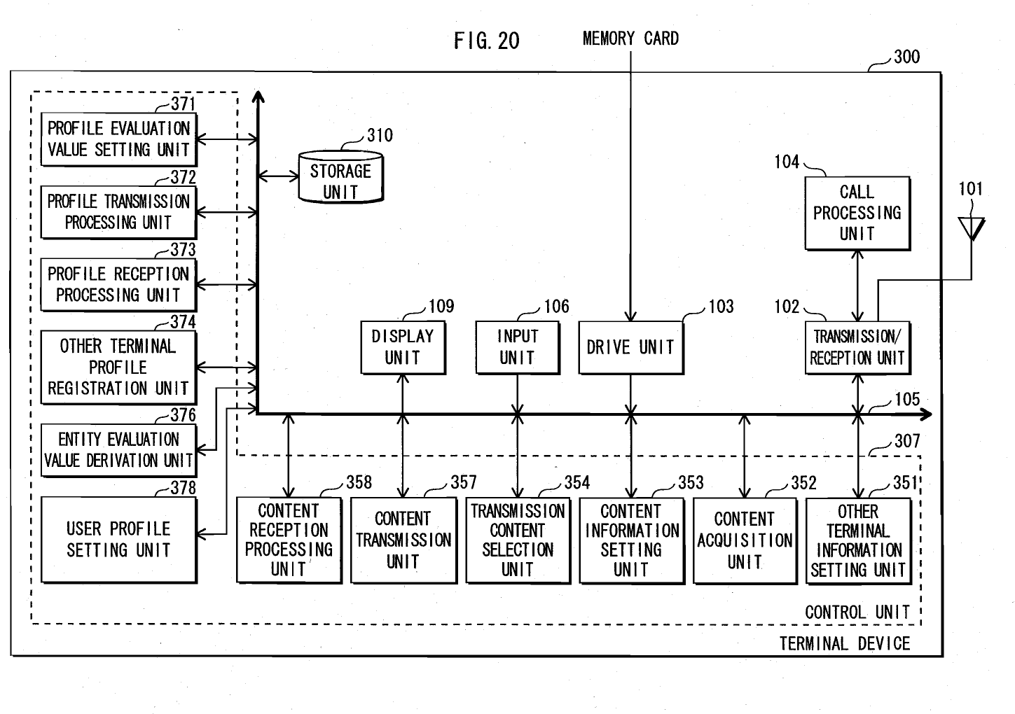

FIG. 20 is a block diagram showing the structure of the terminal device 300. Note that compositional elements of the terminal device 300 having the same functions as those of the terminal device 100A have the same signs as those of the terminal device 100A.

The terminal device 300 includes, as shown in FIG. 20, an antenna 101, a transmission/reception unit 102, a drive unit 103, a call processing unit 104, an input unit 106, a control unit 307, a display unit 109, and a storage unit 310. Each of the compositional units included in the terminal device 300 is connected with the control unit 307 via a bus 105, and operates under control of the control unit 307.

The control unit 307 is specifically a computer system composed of a RAM, a ROM, and a microprocessor. A computer program is stored in the RAM and the ROM. Part of functions of the terminal device 300 is achieved by the microprocessor operating in accordance with the computer program.

The following describes the compositional elements of the terminal device 300. Note that the structures and operations of the antenna 101, the transmission/reception unit 102, the drive unit 103, the call processing unit 104, the input unit 106, and the display unit 109 are the same with those of the terminal device 100A according to the first embodiment. Accordingly, the explanation thereof is omitted here. Furthermore, the explanation of parts of the second embodiment that are similar to or overlapping with those of the first embodiment is simplified, and the explanation is mainly provided for the characteristics of the second embodiment.

(1) Storage Unit 310

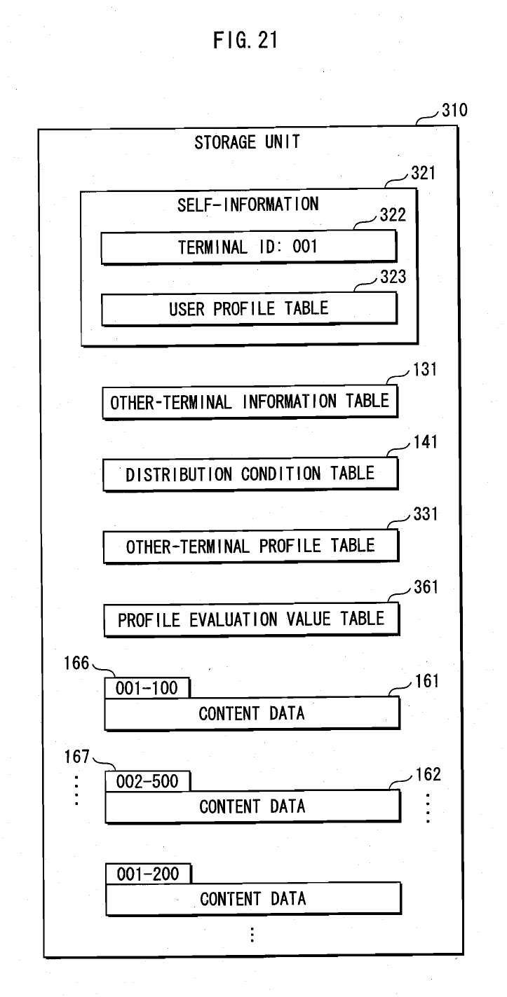

The storage unit 310 is composed of a hard disk and a recording device such as a RAM. FIG. 21 shows an example of information stored in the storage unit 310.

As shown in FIG. 21, the storage unit 310 stores therein self-information 321, an other-terminal information table 131, a distribution condition table 141, an other-terminal profile table 331, a profile evaluation value table 361, pieces of content data 161, 162, . . . , and content IDs 166, 167, . . . , which respectively correspond to the pieces of content data 161, 162, . . . . The other-terminal information table 131, the distribution condition table 141, the pieces of content data 161, 162, . . . , and the content IDs 166, 167, . . . , are the same as those having the same reference numbers in the first embodiment. Therefore, the explanation thereof is omitted here.

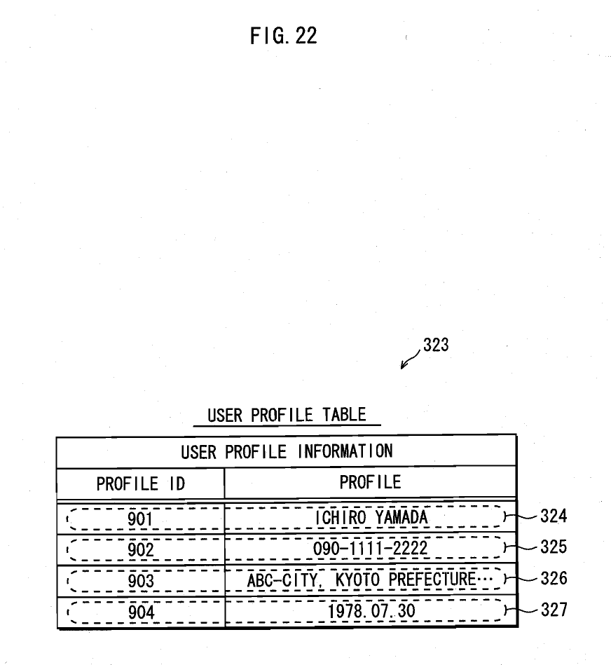

The self-information 321 is composed of information relating to the terminal device 300, and includes a terminal ID 322 and a user profile table 323 here for example. The terminal ID 322 “001” is an identifier uniquely identifying the terminal device 300, like the terminal ID 122 “001” in the first embodiment, which uniquely identifies the terminal device 100A. The user profile table 323 includes profiles relating to a user of the terminal device 300. FIG. 22 shows the structure of the user profile table 323.

As shown in FIG. 22, the user profile table 323 is composed of a plurality of pieces of user profile information, each piece of which is composed of a profile ID and a profile.

The profile constituting the piece of user profile information is a profile relating to the user of the terminal device 300. Here, the profile is represented by at least a single ASCII code. The profile ID indicates a profile type of the profile corresponding thereto. As described above, the profile is a general term for various types of personal information such as a name and an address of a user of a terminal device. The profile ID is an identifier that uniquely identifies any one of the profile types. In the second embodiment, profile IDs “901”, “902”, “903”, and “904” are identifiers that respectively identify a name, a phone number, an address, and a birth date of a user of a terminal device.

For example, user profile information 324 includes the profile ID “901” and a profile “Ichiro Yamada”. This indicates that a name of the user of the terminal device 300 is “Ichiro Yamada”.

At manufacturing of the terminal device 300, all of the profiles included in the user profile table 323 are set as “−99”, which indicates that no profile is set. After purchasing the terminal device 300, each user registers his profile. The profile registration is described later.

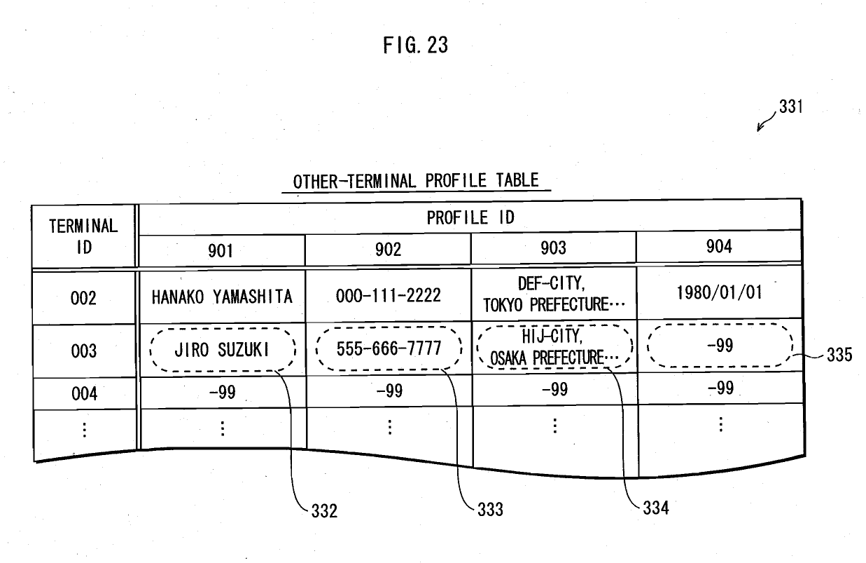

As shown in FIG. 23, the other-terminal profile table 331 has a plurality of profiles arranged thereon, as compositional elements of a matrix having n rows and m columns (n and m are natural numbers no less than 1. In the present embodiment, m=4.). On the other-terminal profile table 331, n terminal IDs “002”, “003”, “004”, are arranged in the column direction, and m (=4) profile IDs “901”, “902”, “903”, and “904” are arranged in the row direction.

Each matrix element of the columns in the other-terminal profile table 331 is a profile that belongs to a profile type identified by a profile ID corresponding thereto. For example, matrix elements of a column corresponding to the profile ID “901” are profiles such as “Hanako Yamashita” and “Jiro Suzuki”, and each of these profiles is a name of a user of a terminal device.

Rows in the other-terminal profile table 331 respectively correspond to the terminal devices included in the information distribution system. Each matrix element of the rows is a profile relating to a user of a terminal device corresponding thereto. Also, rows respectively corresponding to the terminal IDs “002”, “003”, “004”, respectively correspond to the pieces of other-terminal information 132, 133, 134, . . . , which constitute the other-terminal information table 131. For example, a row corresponding to the terminal ID “002” corresponds to the other-terminal information 132 included in the other-terminal information table 131. Each matrix element of this row is a profile relating to a user of a terminal device identified by the terminal ID “002”.

Here, a matrix element “−99” indicates that a corresponding profile is not registered. For example, a matrix element corresponding to the terminal ID “004” and the profile ID “902” is “−99”. This indicates that a phone number of a user of a terminal device identified by the terminal ID “004” is not registered.

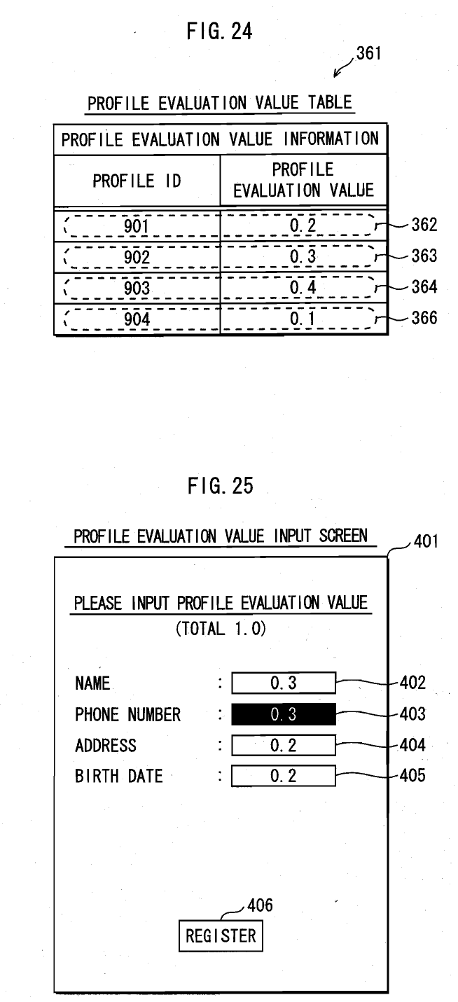

The profile evaluation value table 361 is composed of four pieces of profile evaluation value information 362, 363, 364, and 365, as shown in FIG. 24.

Each piece of the profile evaluation value information includes a profile ID and a profile evaluation value. The profile ID is an identifier that identifies a profile type of a profile, as described already. The profile evaluation value shows, using a numeric value from 0 to 1, an evaluation result of a profile whose profile type is indicated by the profile ID. This shows that the evaluation increases as the numeric value increases. Although the profile evaluation value table 361 is written into the terminal device 300 at manufacturing thereof, profile evaluation values included in the profile evaluation value table 361 may be changed by users after shipment of the terminal device 300. What kind of evaluation criterion is used for determining profile evaluation values depends on manufacturers of the terminal device 300, telecom companies that sell the terminal device 300, or users who purchase the terminal device 300. For example, a profile evaluation value is determined depending on the degree of importance of a profile type of a profile, the degree of ease of identifying each user individually, and so on.

Note that the index of profile evaluation value is standardized in the second embodiment such that the total of profile evaluation values is “1.0”, in order to ensure consistency with other indexes such as the index of entity evaluation value and the index of distribution threshold.

(2) Control Unit 307

The control unit 307 includes, as shown in FIG. 20, an other-terminal information setting unit 351, a content acquisition unit 352, a content information setting unit 353, a transmission content selection unit 354, a content transmission processing unit 357, a content reception processing unit 358, a profile evaluation value setting unit 371, a profile transmission processing unit 372, a profile reception processing unit 373, an other-terminal profile registration unit 374, an entity evaluation value derivation unit 376, and a user profile setting unit 378.

FIG. 20 shows the functional structure of the control unit 307. As described above, the control unit 307 specifically includes the processor, the RAM, and the ROM. Programs having written therein processing performed by the functional units are stored in the RAM and the ROM. The functional units are realized by the processor operating in accordance with the programs.

The following describes the functional units of the control unit 307. The operations of the transmission content selection unit 354 are the same as those of the transmission content selection unit 154 of the first embodiment, and therefore the explanation thereof is omitted here.

Also, the operations of the content acquisition unit 352 are the same as those of the content acquisition unit 152 of the first embodiment, except that the content acquisition unit 352 does not perform generation and addition of content evaluation value information (Step S139 in FIG. 13).

The operations of the content transmission processing unit 357 are the same as those of the content transmission processing unit 157 of the first embodiment, except that the content transmission processing unit 357 does not output terminal IDs and content IDs to the entity evaluation value derivation unit 376 after transmitting content data.

The operations of the content reception processing unit 358 are the same as those of the content reception processing unit 158 of the first embodiment, except that the content reception processing unit 358 does not perform generation and addition of content evaluation value information (Step S249 in FIG. 19).

Therefore, the explanation of the content acquisition unit 352, the content transmission processing unit 357, and the content reception processing unit 358 is also omitted.

(2-1) Other-Terminal Information Setting Unit 351

Through the same procedure as that of the other-terminal information setting unit 151 of the first embodiment, the other-terminal information setting unit 351 generates a new piece of other-terminal information, and adds the generated piece of other-terminal information to the other-terminal information table 131.

Furthermore, the other-terminal information setting unit 351 adds a new row corresponding to an input terminal ID to the other-terminal profile table 331. Each of four matrix elements of the added row is “−99”, which indicates that no profile is set.

(2-2) Content Information Setting Unit 353

Through almost the same procedure as that of the content information setting unit 153 of the first embodiment, the content information setting unit 353 sets content information. However, since content evaluation values do not exist in the second embodiment, the content information setting screen 181 generated by the content information setting unit 353 does not include a content evaluation value input field. The content information setting unit 353 only updates distribution thresholds.

Furthermore, in Step S152 in FIG. 15, if a piece of content data received from another terminal device is selected by the user, (that is, if top three digits of a content ID identifying the selected piece of content data do not match the terminal ID 322 “001”), the content information setting unit 353 generates an error screen for notifying that a distribution threshold of the selected piece of content data cannot be changed, instead of generating a content information setting screen. Then, the display unit 109 displays the generated error screen.

(2-3) Profile Evaluation Value Setting Unit 371

The profile evaluation value setting unit 371 receives, via the input unit 106, operation instruction information for instructing to set a profile evaluation value. Upon receiving the operation instruction information, the profile evaluation value setting unit 371 generates a profile evaluation value input screen based on the screen data stored in the storage unit 310 and a profile evaluation value included in the profile evaluation value table 361, and displays the generated profile evaluation value input screen on the display unit 109.

FIG. 25 shows an example of the profile evaluation value input screen generated here. As shown in FIG. 25, a profile evaluation value input screen 401 includes profile evaluation value input fields 402 to 405 and a register button 406. The profile evaluation value input fields 402 to 405 respectively correspond to the pieces of profile evaluation value information 362, 363, 364, and 366.

The profile evaluation value setting unit 371 displays, on each of the profile evaluation value input fields, a profile evaluation value included in a piece of profile evaluation value information corresponding to the profile evaluation value input field.

The user operates a ten key, direction keys, and the like included in the input unit 106 to point a cursor to any one of the profile evaluation value input fields, and inputs a numeric value from 0 to 1.0.

If the register button 406 is pressed by the user's operation, the profile evaluation value setting unit 371 updates each of the profile evaluation values included in the corresponding piece of profile evaluation value information to the input numeric value.

(2-4) Profile Transmission Processing Unit 372

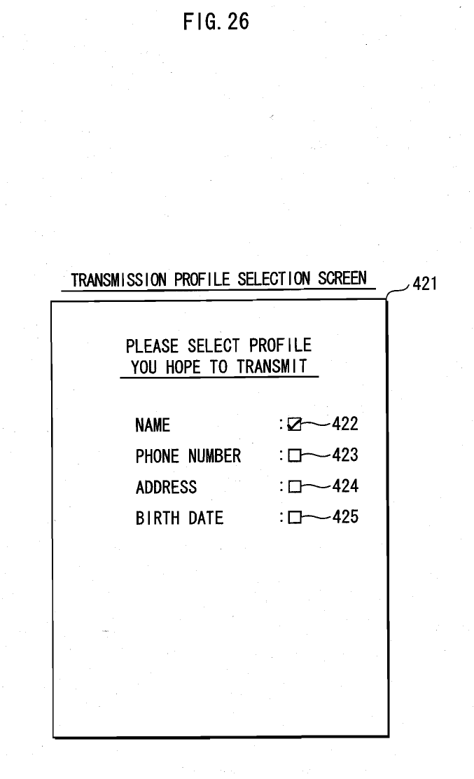

The profile transmission processing unit 372 receives operation instruction information for instructing to transmit a profile from the input unit 106. Upon receiving the operation instruction information to transmit a profile, the profile transmission processing unit 372 generates a transmission profile selection screen based on the screen data stored in the storage unit 310, and displays the generated transmission profile selection screen on the display unit 109. FIG. 26 shows an example of the transmission profile selection screen generated here.

The transmission profile selection screen 421 includes four check boxes 422 to 425. Alongside of the check boxes, profile type names including a “name”, a “telephone number”, an “address”, and a “birth date”. The check boxes 422 to 425 respectively correspond to the pieces of user profile information 324 to 327 constituting the user profile table 323.

The user checks any one of the check boxes alongside of a profile type name of a profile the user hopes to transmit, and presses the determine button included in the input unit 106.

When the determine button is pressed, the profile transmission processing unit 372 reads a profile ID and a profile from a piece of user profile information corresponding to the checked check box.

Then, the profile transmission processing unit 372 generates a transmission destination selection screen, and displays the generated transmission destination selection screen on the display unit 109. The transmission destination selection screen displayed here is for example the same as the transmission destination selection screen 201 described using FIG. 10. If a transmission destination terminal is selected by the user's operation, the profile transmission processing unit 372 reads a piece of transmission destination information from a piece of other-terminal information corresponding to the selected transmission destination terminal in the other-terminal information table 131.

Then, the profile transmission processing unit 372 reads the terminal ID 322 “001” that identifies the terminal device 300 from the storage unit 310. The profile transmission processing unit 372 transmits the read terminal ID 322 “001”, profile ID, and profile to a terminal device indicated by the read piece of transmission destination information via the antenna 101 and the transmission/reception unit 102.

(2-5) Profile Reception Processing Unit 373

The profile reception processing unit 373 receives a terminal ID, a profile, and a profile ID corresponding to the profile from another terminal device via the antenna 101 and the transmission/reception unit 102.

The profile reception processing unit 373 generates a profile receiving screen including the received profile, the received terminal ID, a registered name corresponding to the terminal ID, and so on, and displays the generated profile receiving screen on the display unit 109, and notifies the user of reception of the profile.

Next, the profile reception processing unit 373 outputs the received terminal ID and profile ID to the entity evaluation value derivation unit 376.

Next, the profile reception processing unit 373 receives an end notification indicating the end of entity evaluation value update processing from the entity evaluation value derivation unit 376. Upon receiving the end notification, the profile reception processing unit 373 writes the received profile into the other-terminal profile table 331, as a matrix element corresponding to the received terminal ID and profile ID.

Although the case where one pair of a profile and a profile ID is received has been described, a plurality of pairs of a profile and a profile ID may be received. In such a case, output of a terminal ID and a profile ID and update of a matrix element are repeatedly performed for each of the pairs.

(2-6) Other-Terminal Profile Registration Unit 374

The other-terminal profile registration unit 374 receives, from the input unit 106, operation instruction information for instructing the user's registration of a profile of a user of another terminal device. Upon receiving the operation instruction information, the other-terminal profile registration unit 374 reads a terminal ID and a registered name from each piece of the other-terminal information that constitutes the other-terminal information table 131, and generates a registration target selection screen based on the screen data stored in the storage unit 310, and displays the generated registration target selection screen on the display unit 109. Like the transmission destination selection screen 201 shown in FIG. 10, the registration target selection screen generated here displays a list of the read terminal IDs and registered names. The user operates the direction keys and the determine key to select a terminal device the user hopes to register a profile thereof (herein after, referred to as a “registration target terminal”).

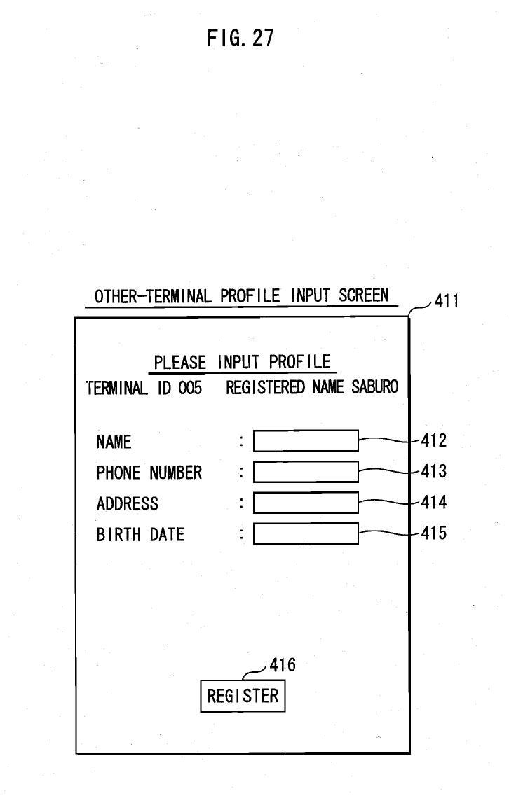

The other-terminal profile registration unit 374 receives the user's selection of the registration target terminal via the input unit 106. Then, the other-terminal profile registration unit 374 reads four matrix elements of a row corresponding to the terminal ID that identifies the registration target terminal from the other-terminal profile table 331. The other-terminal profile registration unit 374 generates another-terminal profile input screen using the read matrix elements, the terminal ID and the registered name corresponding to the registration target terminal, and displays the generated other-terminal profile input screen on the display unit 109. FIG. 27 shows an example of another-terminal profile input screen 411 generated here. The other-terminal profile input screen 411 includes a terminal ID and a registered name corresponding to a registration target terminal, four input fields 412 to 415, and a register button 416.

The four input fields 412 to 415 respectively correspond to the profile IDs “901” to “904”. On the other-terminal profile input screen 411, alongside of each of the input fields, a profile type name of a profile identified by a profile ID corresponding to the input field is written.

The other-terminal profile registration unit 374 writes beforehand the matrix elements read from the other-terminal profile table 331 into the input field.

For example, if a terminal device identified by the terminal ID “003” is the registration target terminal, the other-terminal profile registration unit 374 writes a matrix element 332 “Jiro Suzuki” corresponding to the terminal ID “003” and the profile ID “901” into the input field 412 corresponding to the profile ID “901”. Likewise, the other-terminal profile registration unit 374 writes a matrix element 333 “555-666-7777” and a matrix element 334 “XX-City, Osaka Prefecture” respectively corresponding to the profile IDs “902” and “903” into the input fields 413 and 414 respectively corresponding to the profile IDs “902” and “903”. Note that since a matrix element 335 corresponding to the profile ID “904” is “−99” representing that no profile is set, the other-terminal profile registration unit 374 leaves the input field 415 blank.

The user operates various kinds of keys included in the input unit 106 to input data into the input fields and press the register button 416.

Upon detecting the press of the register button 416 via the input unit 106, the other-terminal profile registration unit 374 firstly outputs, to the entity evaluation value derivation unit 376, the profile ID “901” corresponding to the input field 412 and the terminal ID identifying the registration target terminal. Next, the other-terminal profile registration unit 374 receives an end notification indicating the end of entity evaluation value update processing from the entity evaluation value derivation unit 376. Upon receiving the end notification, the other-terminal profile registration unit 374 updates a matrix element specified by the terminal ID identifying the registration target terminal and the profile ID “901” corresponding to the input field 412 to the data input into the input field 412.

Then, the other-terminal profile registration unit 374 updates matrix elements for each of the input fields 413 to 415 through the same procedure.

Note that if an input field is blank, the other-terminal profile registration unit 374 does not perform the above processing.

(2-7) Entity Evaluation Value Derivation Unit 376

The entity evaluation value derivation unit 376 stores therein a first specific gravity value and a second specific gravity value. Both of the values are decimal numbers from 0 to 1. These specific gravity values may be stored at manufacturing of the terminal device 300, or may be set by sellers at selling of the terminal device 300, or may be set by users after purchasing the terminal device 300.

The entity evaluation value derivation unit 376 receives a terminal ID and a profile ID from the profile reception processing unit 373 and the other-terminal profile registration unit 374.

Upon receiving the terminal ID and the profile ID, the entity evaluation value derivation unit 376 reads, from the other-terminal profile table stored in the storage unit 310, a matrix element corresponding to the received terminal ID and profile ID.

If the read matrix element is not “−99”, the entity evaluation value derivation unit 376 does not perform the processing described below, and outputs an end notification indicating the end of the entity evaluation value update processing to a reception source of the terminal ID and the profile ID.

If the read matrix element is “−99”, the entity evaluation value derivation unit 376 then selects any one of the stored two specific gravity values depending on the reception source of the terminal ID and the profile ID. If the reception source is the profile reception processing unit 373, the entity evaluation value derivation unit 376 selects the first specific gravity value. If the reception source is the other-terminal profile registration unit 374, the entity evaluation value derivation unit 376 selects the second specific gravity value.

Next, the entity evaluation value derivation unit 376 selects a piece of other-terminal information including the received terminal ID from the other-terminal information table 131 stored in the storage unit 310, and reads an entity evaluation value included in the selected piece of other-terminal information.

Then, the entity evaluation value derivation unit 376 selects a piece of profile evaluation value information including the received profile ID from the profile evaluation value table 361 stored in the storage unit 310, and reads a profile evaluation value included in the selected piece of profile evaluation value information.

Next, the entity evaluation value derivation unit 376 calculates a product of the read profile evaluation value and the selected specific gravity, and then calculates a sum of the product and the read entity evaluation value. Then, the entity evaluation value derivation unit 376 updates the entity evaluation value included in the selected piece of other-terminal information to the calculation result.

Next, the entity evaluation value derivation unit 376 outputs an end notification indicating the end of the entity evaluation value update processing to the reception source of the terminal ID and the profile ID.

(2-8) User Profile Setting Unit 378

The user profile setting unit 378 receives operation instruction information for instructing to register a user profile via the input unit 106. Upon receiving the operation instruction information, the user profile setting unit 378 generates a user profile input screen based on the screen data stored in the storage unit 310, and displays the generated user profile input screen on the display unit 109.

Like the other-terminal profile input screen 411 described using FIG. 27, the user profile input screen generated here includes four input fields, each of which respectively correspond to the pieces of user profile information 324 to 327 constituting the user profile table 323.

The user profile setting unit 378 receives input of data into each of the input fields by the user. Then, the user profile setting unit 378 updates a profile evaluation value included in a piece of user profile information corresponding to the input field to the input data.

### 2.3 Operations

The following describes the operations of the terminal device 300 with reference to the drawings.

(1) Operations of Terminal Device 300

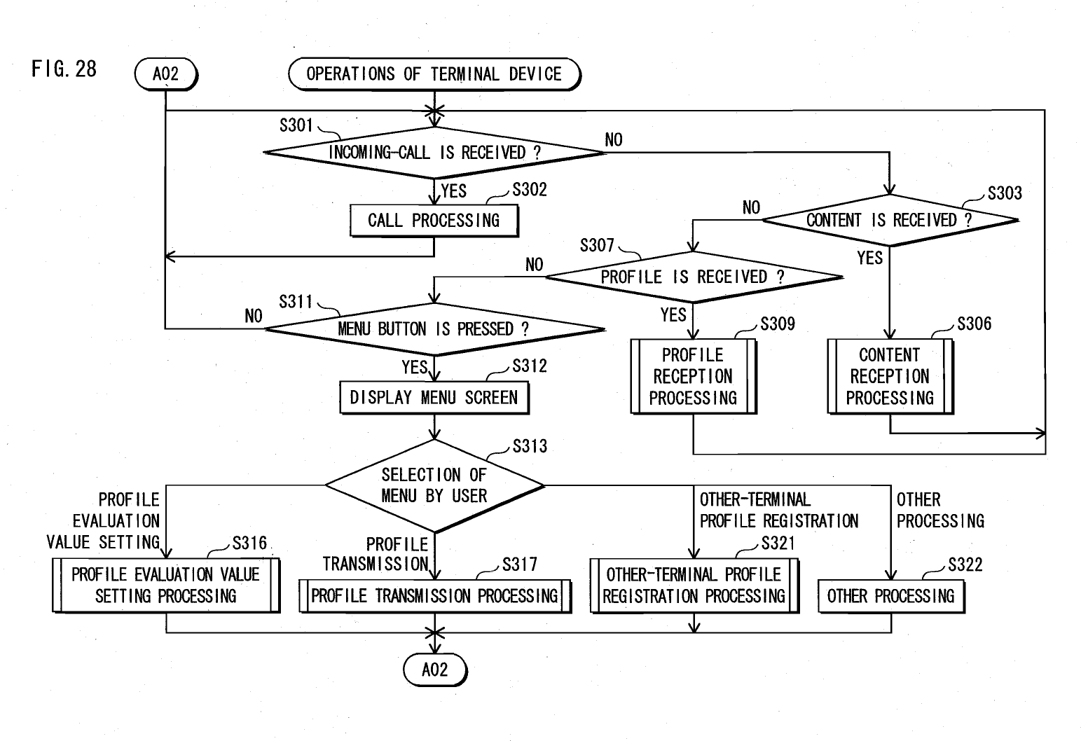

FIG. 28 is a flow chart showing the operations of the terminal device 300. The following describes the operations of the terminal device 300 with reference to FIG. 28. Note that the explanation starts with Step S301 for convenience.

The terminal device 300 in the normal standby mode is waiting until anyone of an incoming-call, reception of content data, reception of a profile, the user's press of the menu button has been detected (Steps S301, 303, 307, and S311: NO).

If an incoming-call is detected (Step S301: YES), the call processing unit 104 performs call processing between the terminal device 300 and an external terminal device via the antenna 101 and the transmission/reception unit 102 (Step S302). When the call ends, the flow returns to Step S301.

Moreover, if content data is received (Step S303: YES), the content reception processing unit 358 performs content reception processing (Step S306). The content reception processing in the second embodiment is the same as the content reception processing in the first embodiment (see FIG. 19), except that the content reception processing in the second embodiment does not include Step S249. When the content reception processing ends, the flow returns to Step S301.

If a profile is received (Step S307: YES), the profile reception processing unit 373 starts profile reception processing which is described in detail later (Step S309). When the profile reception processing ends, the flow returns to Step S301.

When the user's press of the menu button is detected (Step S311: YES), the control unit 307 generates a menu screen, and outputs the menu screen to the display unit 109. The display unit 109 displays the menu screen (Step S312).

Then, the control unit 307 receives the user's selection of a menu via the input unit 106 (Step S313).

If receiving an instruction to set a profile evaluation value by the user's operation (Step S313: “profile evaluation value setting”), the profile evaluation value setting unit 371 performs profile evaluation value setting processing which is described in detail later (Step S316).

If receiving an instruction to transmit a profile by the user's operation (Step S313: “profile transmission”), the profile transmission processing unit 372 performs profile transmission processing (Step S317).

Also, if receiving an instruction to register other-terminal profile by the user's operation (Step S313: “other-terminal profile registration”), the other-terminal profile registration unit 374 starts other-terminal profile registration processing (Step S321).

Furthermore, if receiving an instruction to perform other processing by the user's operation such as transmission of content data and registration of other-terminal information (Step S313: “other processing”), the control unit 307 performs various kinds of other processing in accordance with the instruction.

After the processing in Steps S316 to S322 ends, the flow returns to Step S301.

(2) Profile Evaluation Value Setting Processing

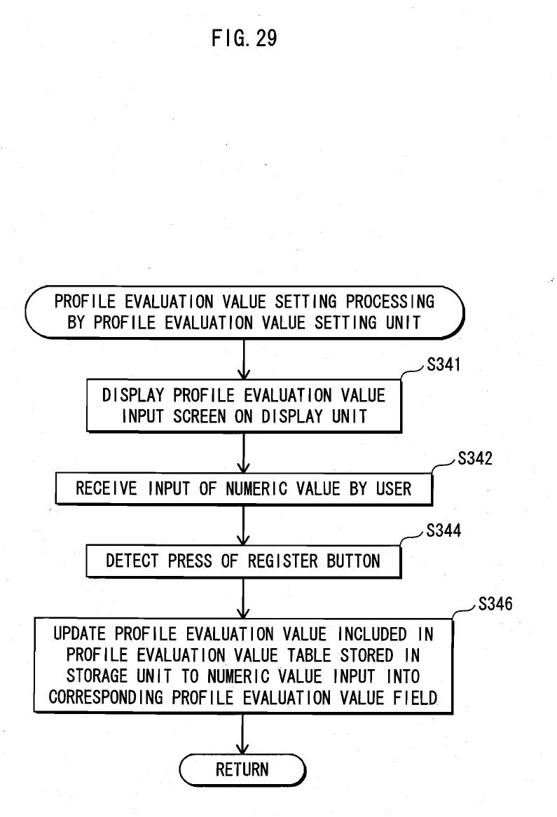

FIG. 29 is a flow chart showing profile evaluation value setting processing performed by a profile evaluation value setting unit 371. FIG. 29 shows the details of Step S316 in FIG. 28. The following describes the profile evaluation value setting processing with reference to FIG. 29.

The profile evaluation value setting unit 371 generates the profile evaluation value input screen 401. The display unit 109 displays the generated profile evaluation value input screen 401 (Step S341).

Then, the profile evaluation value setting unit 371 receives input of a numeric value by the user (Step S342). Upon detecting press of the register button 416 via the input unit 106 (Step S344), the profile evaluation value setting unit 371 updates a profile evaluation value included in the profile evaluation value table 361 to the numeric value input into a corresponding profile evaluation value field (Step S346).

(3) Profile Transmission Processing

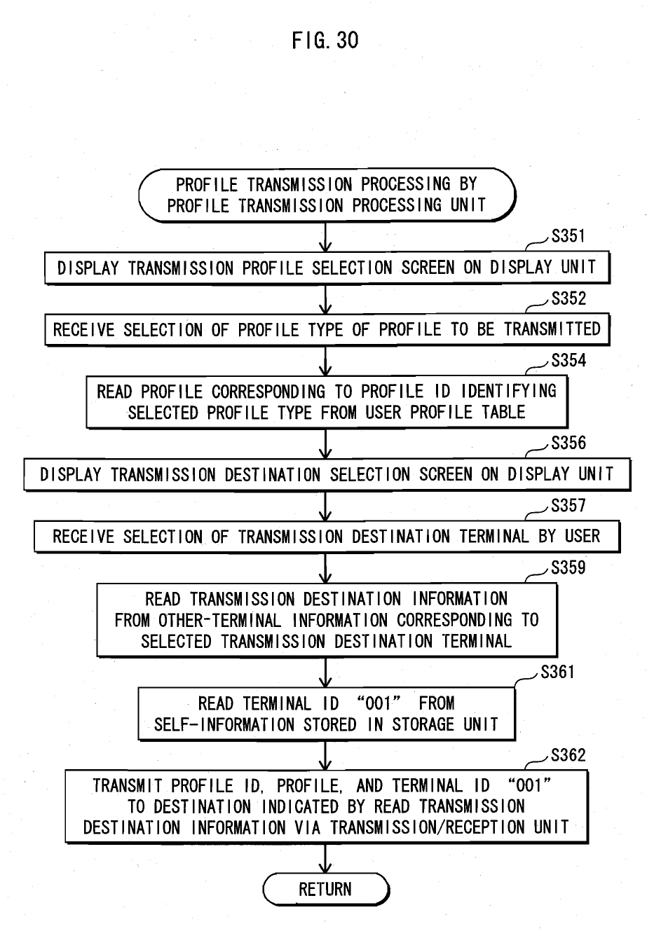

FIG. 30 is a flow chart showing profile transmission processing performed by the profile transmission processing unit 372. FIG. 30 shows the details of Step S317 shown in FIG. 28. The following describes the profile transmission processing with reference to FIG. 30.

The profile transmission processing unit 372 displays the transmission profile selection screen 421 on the display unit 109 (Step S351), and receives the user's selection of a profile type of a profile the user hopes to transmit (Step S532).

Next, the profile transmission processing unit 372 reads a profile corresponding to a profile ID that identifies the selected profile type from the user profile table 323 (Step S354).

Then, the profile transmission processing unit 372 displays the transmission destination selection screen 201 on the display unit 109 (Step S356). Next, the profile transmission processing unit 372 receives the user's selection of a transmission destination terminal (Step S357), and reads a piece of transmission destination information from a piece of other-terminal information corresponding to the selected transmission destination terminal (Step S359). Then, the profile transmission processing unit 372 reads the terminal ID 322 “001” from the storage unit 310 (Step S361), and transmits the terminal ID 322 “001”, the profile ID, and the profile to a transmission destination indicated by the piece of transmission destination information (Step S362).

(4) Profile Reception Processing

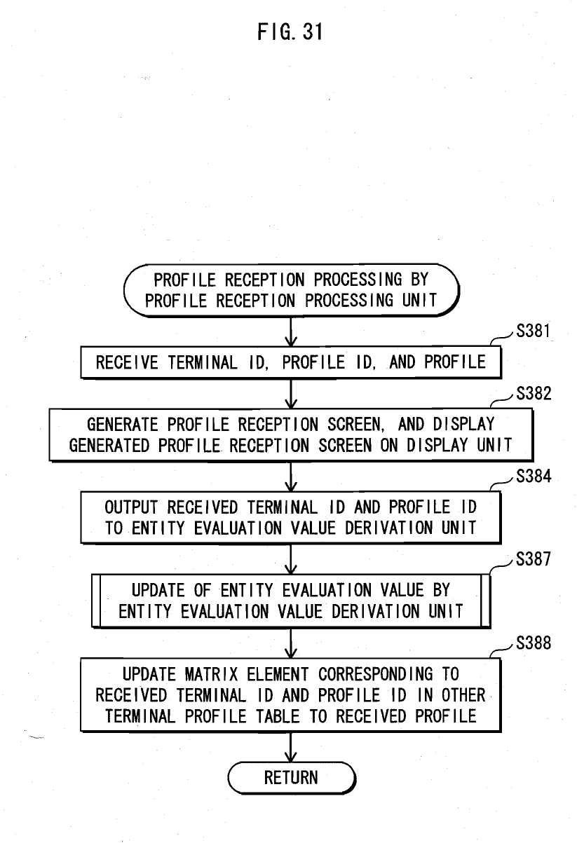

FIG. 31 is a flowchart showing the profile reception processing. FIG. 31 shows the details of Step S309 in FIG. 28. The following describes the profile reception processing with reference to FIG. 31.

The profile reception processing unit 373 receives a terminal ID, a profile ID, and a profile via the antenna 101 and the transmission/reception unit 102 (Step S381).

Upon receiving the terminal ID, the profile ID, and the profile, the profile reception processing unit 373 generates a profile receiving screen. The display unit 109 displays the generated profile receiving screen (Step S382).

Then, the profile reception processing unit 373 outputs the received terminal ID and profile ID to the entity evaluation value derivation unit 376 (Step S384). The entity evaluation value derivation unit 376 receives the terminal ID and the profile ID from the profile reception processing unit 373, and performs entity evaluation value update processing which is described in detail later (Step S387).

Then, the profile reception processing unit 373 receives an end notification indicating the end of the entity evaluation value update processing from the entity evaluation value derivation unit 376, and updates a matrix element corresponding to the received terminal ID and profile ID in the other-terminal profile table 331 to the received profile (Step S388).

(5) Other-Terminal Profile Registration Processing

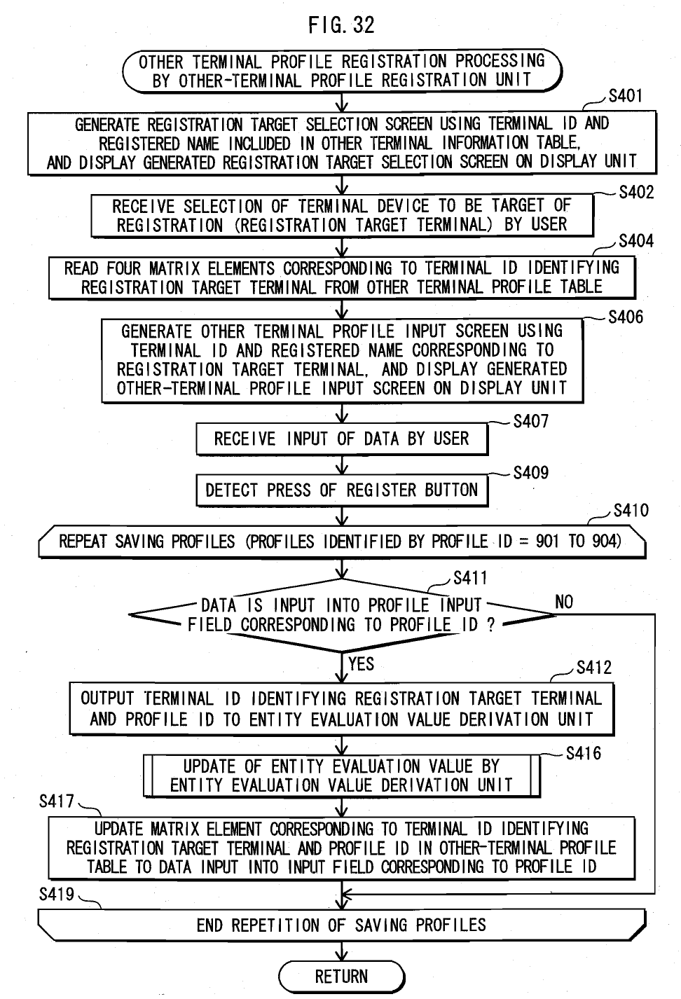

If receiving an instruction to register other-terminal profile by the user's menu selection, the terminal device 300 starts other-terminal profile registration processing. FIG. 32 is a flow chart showing the other-terminal profile registration processing. FIG. 32 shows the details of Step S321 in FIG. 28. The following describes the other-terminal profile registration processing with reference to FIG. 32.

The other-terminal profile registration unit 374 reads terminal IDs and registered names from each piece of other-terminal information included in the other-terminal information table 131, and generates a registration target selection screen using the read terminal IDs and registered names. The display-unit 109 displays the generated registration target selection screen (Step S401).

Next, the other-terminal profile registration unit 374 receives the user's selection of a registration target terminal via the input unit 106 (Step S402). Next, the other-terminal profile registration unit 374 reads four matrix elements corresponding to a terminal ID that identifies the selected registration target terminal from the other-terminal profile table 331 (Step S404).

The other-terminal profile registration unit 374 generates the other-terminal profile input screen 411 using the terminal ID and a registered name corresponding to the registration target terminal and the four read matrix elements. The display unit 109 displays the generated other-terminal profile input screen 411 (Step S406).

While the display unit 109 displays the other-terminal profile input screen 411, the other-terminal profile registration unit 374 receives the user's input of data into the four input fields 412 to 415 (Step S407).

Then, the other-terminal profile registration unit 374 detects press of the register button 416 (Step S409). During the processing in Steps from S410 to S419, the other-terminal profile registration unit 374 repeatedly performs Steps S411 to S417 on the profile IDs “901” to “904” respectively.

On the other-terminal profile input screen 411, if no data is input into an input field corresponding to a profile ID (Step S411: NO), the other-terminal profile registration unit 374 does not perform Steps S412 to S417, and performs processing on a next profile ID.

If data is input into the input field corresponding to the profile ID (Step S411: YES), the other-terminal profile registration unit 374 outputs the terminal ID identifying the registration target terminal and the profile ID to the entity evaluation value derivation unit 376 (Step S412). The entity evaluation value derivation unit 376 receives the terminal ID and the profile ID from the other-terminal profile registration unit 374, and updates the entity evaluation value of the registration target terminal based on the received terminal ID and profile ID (Step S416). After updating the entity evaluation value, the entity evaluation value derivation unit 376 outputs an end notification indicating the end of the entity evaluation value update processing to the other-terminal profile registration unit 374.

The other-terminal profile registration unit 374 receives the end notification from the entity evaluation value derivation unit 376, and updates the matrix element corresponding to the terminal ID identifying the registration target terminal and the profile ID in the other-terminal profile table 331 to the data input into the input field corresponding to the profile ID (Step S417).

(6) Entity Evaluation Value Update Processing

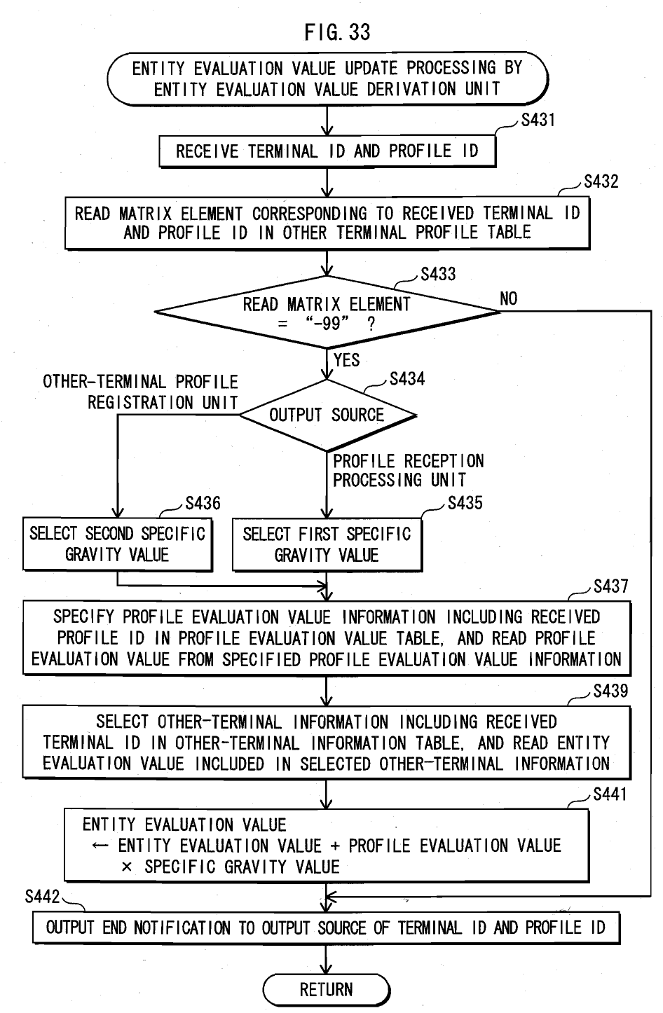

FIG. 33 is a flow chart showing the entity evaluation value update processing performed by the entity evaluation value derivation unit 376. FIG. 33 shows the details of Step S387 in FIG. 31 and Step S416 in FIG. 32. The following describes the entity evaluation value update processing with reference to FIG. 33.

The entity evaluation value derivation unit 376 receives a terminal ID and a profile ID from the profile reception processing unit 373 or the other-terminal profile registration unit 374 (Step S431).

Upon receiving the terminal ID and the profile ID, the entity evaluation value derivation unit 376 reads a matrix element corresponding to the received terminal ID and profile ID from the other-terminal profile table 331 (Step S432). If the read matrix element is not “−99” (Step S433: NO), the entity evaluation value derivation unit 376 does not perform the following Steps S434 to 441.

If the read matrix element is “−99” (Step S433: YES), and further if an output source of the terminal ID and the profile ID is the profile reception processing unit 373 (S434: “the profile reception processing unit”), the entity evaluation value derivation unit 376 selects the first specific gravity value from the two stored specific gravity values (Step S435).

If the read matrix element is “−99” (Step S433: YES), and further if the output source is the other-terminal profile registration unit 374 (S434: “the other-terminal profile registration unit”), the entity evaluation value derivation unit 376 selects the second specific gravity value from the two stored specific gravity values (Step S436).

Next, in the profile evaluation value table 361, the entity evaluation value derivation unit 376 specifies a piece of profile evaluation value information including the received profile ID, and reads a profile evaluation value included in the specified piece of profile evaluation value information (Step S437).

Next, the entity evaluation value derivation unit 376 selects apiece of other-terminal information including the received terminal ID from the other-terminal information table 131, and reads an entity evaluation value included in the selected piece of other-terminal information (Step S439).

Then, the entity evaluation value derivation unit 376 calculates a product of the read profile evaluation value and the selected specific gravity value, and calculates a sum of the product and the read entity evaluation value, and then updates the entity evaluation value included in the selected piece of other-terminal information to the calculated sum (Step S441).

Next, the entity evaluation value derivation unit 376 outputs an end notification indicating the end of the entity evaluation value update processing to the output source of the terminal ID and the profile ID (Step S442).

### 2.4 Conclusion and Effects

As have been described, the terminal device 300 according to the second embodiment acquires a profile relating to a user of another terminal device via the user's input or communication with the another terminal device. Then, the terminal device 300 generates an entity evaluation value of the another terminal device using a profile evaluation value corresponding to the acquired profile.

With such a structure, the terminal device 300 generates an entity evaluation value by using the profile evaluation value as the uniform criterion.

Also, the terminal device 300 determines, as an entity evaluation value of the another terminal device, a sum of a product generated by multiplying a profile evaluation value corresponding to an acquired profile by a specific gravity value defined in accordance with acquisition path of the profile and an entity evaluation value included in other-terminal information corresponding to the another terminal device. Therefore, the terminal device 300 can increase an entity evaluation value of a terminal device whose user discloses more profiles to the terminal device 300.

### 3. Modifications

While the present invention has been described based on the above embodiments, the present invention is by no means limited to the above embodiments. The present invention also includes the following cases.

(1) In the first embodiment, each time the terminal device 100A transmits content data to a terminal device, the terminal device 100A updates an entity evaluation value of the terminal device. However, the present invention is not limited to this structure. The following may be employed. The terminal device 100A stores therein a transmission history, and updates the entity evaluation value periodically or in response to an update instruction by the user of the terminal device 100A.

Specifically, each time the transmission processing unit 157 transmits a piece of content data, the transmission processing unit 157 generates a transmission history composed of a terminal ID identifying a transmission destination terminal and a content ID identifying the transmitted piece of content data, and writes the generated transmission history into the storage unit 110.

The entity evaluation value derivation unit 156 updates an entity evaluation value of the transmission destination terminal through the following procedure periodically or in response to an update instruction by the user's operation. Note that the procedure described here is just an example.

Firstly, the entity evaluation value derivation unit 156 reads the terminal ID “002” from the other-terminal information 132 that positions at the head in the other-terminal information table 131, and specifies transmission histories including the read terminal ID “002”. The entity evaluation value derivation unit 156 reads, for each of the specified transmission histories, a content evaluation value corresponding to a content ID included in the transmission history from the content evaluation value table 145. Next, the entity evaluation value derivation unit 156 specifies the highest value among the read content evaluation values, and replaces the entity evaluation value included in the other-terminal information 132 with the specified highest value.

Likewise, for each piece of the other-terminal information 133, 134, . . . , the entity evaluation value derivation unit 156 also performs entity evaluation value update processing based on transmission histories including a corresponding terminal ID.

(2) Moreover, in the first embodiment, only content data that has been actually transmitted is used for generating entity evaluation values. However, the present invention is not limited to this structure. Although having not been actually transmitted, content data that the user of the terminal device 100A hopes to transmit may be used for generating entity evaluation values.

Specifically, in Step S187 in FIG. 16, if the distribution threshold is greater than the entity evaluation value (Step S187: NO), the transmission content selection unit 154 outputs, to the entity evaluation value derivation unit 156, the terminal ID identifying the transmission destination terminal selected by the user and the content ID identifying the piece of content data selected by the user. Regardless of whether transmission of the piece of content data is permitted, the entity evaluation value derivation unit 156 updates the entity evaluation value through the procedure shown in FIG. 18 based on the received terminal ID and content ID.

The first embodiment has been described based on the assumption that the information distribution system 1 determines whether transmission of content data is permitted using generated entity evaluation values. Accordingly, if a transmission destination terminal does not satisfy a condition for transmission of a piece of content data, the transmission is cancelled. However, the user selects the piece of content data as a transmission target to the transmission destination terminal. In other words, the user of the terminal device 100A intends to transmit the piece of content data to the transmission destination terminal. Therefore, if the piece of content data is not actually transmitted, an entity evaluation value of the transmission destination terminal may be determined by reflecting the user's intention.

(3) The first embodiment has the structure that the highest value among content entity evaluation values corresponding to pieces of content data that have ever been transmitted to a transmission destination terminal is determined as an entity evaluation value of the transmission destination terminal. The present invention is not limited to this structure. Like the casein the second embodiment, the sum of the content entity evaluation values corresponding to the pieces of content data transmitted to the transmission destination terminal may be determined as the entity evaluation value of the transmission destination terminal.

Also, in the first and second embodiments, the entity evaluation values have been described to be in the range from 0 to 1. However, since a criterion that is uniform within the system only needs to be used, the entity evaluation values are not limited to the above value range.

(4) In the first embodiment, an entity evaluation value of a terminal device is determined in consideration of all of the pieces of content data that have ever been transmitted to the terminal device. However, the present invention is not limited to this structure. The entity evaluation value may be determined in consideration of only a piece of content data that has been recently transmitted to the terminal device.

Specifically, like the case in the above described modification (1), entity evaluation values are generated using transmission histories. In this case, each of the transmission histories includes a terminal ID identifying a transmission destination terminal, a content ID, and a transmission date.

The entity evaluation value derivation unit 156 reads the terminal ID “002” from the other-terminal information 132 that positions at the head in the other-terminal information table 131, and specifies transmission histories including the read terminal ID “002”. Here, the entity evaluation value derivation unit 156 excludes a transmission history including a transmission date preceding a predetermined period (a date six months before, for example). After this, like the case in the modification (1), the entity evaluation value derivation unit 156 generates an entity evaluation value of a terminal device identified by the terminal ID “002”.

(5) In the first embodiment, as one of the easiest examples of generation of content evaluation values, input of content evaluation values by the user has been described. Alternatively, with no operations by the user, a content evaluation value of a piece of content data may be automatically generated in accordance with a situation at the time of generating the piece of content data and information included in the piece of content data.

The following cases are specific examples. Note that the terminal device 100A here includes a photographing unit with a function for taking photographs, and generates content data (photographs).

(5-1) Generation of Content Evaluation Value in Accordance with Photographing Location

In the modification (5-1), the terminal device 100A includes a GPS function.

At the time of purchase of the terminal device 100A for example, home position information indicating a position of the user's home into the terminal device 100A is registered by default.

When the photographing unit takes a photograph in accordance with the user's operation, the content acquisition unit 152 acquires, using the GPS function, position information indicating a current position of the terminal device 100A (herein after, referred to as “photographing position information”). The photographing position information is composed of the latitude and the longitude of the position.

Next, the content acquisition unit 152 generates a content ID through the procedure described in the first embodiment, and writes the generated content ID, a piece of content data (the photograph taken by the photographing unit), and the acquired photographing position information into the storage unit 110 in correspondence with each other.

Then, the content acquisition unit 152 calculates a slant distance between the position indicated by the photographing position information and the position indicated by the home position information. Next, the content acquisition unit 152 determines a content evaluation value of the piece of content data in accordance with the calculated slant distance such that a higher content evaluation value corresponds to a shorter slant distance, and a lower content evaluation value corresponds to a longer slant distance.

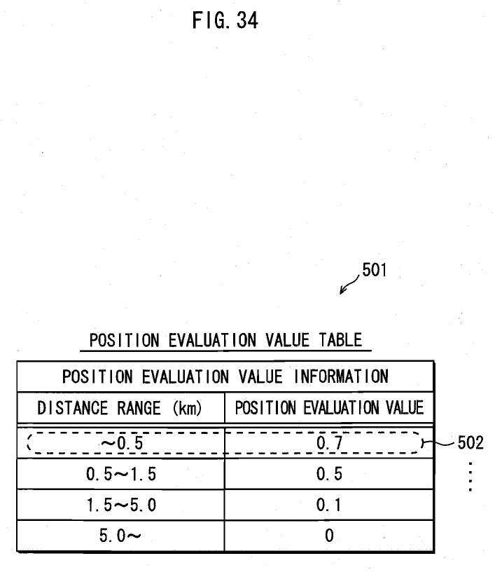

Specifically, the storage unit 110 stores therein a position evaluation value table 501 showing the correspondence between the ranges of distance from the home to the photographing position and values corresponding to the ranges of distance (decimal numbers from 0 to 1.0, herein after, referred to as “position evaluation values”). FIG. 34 shows an example of the structure of the position evaluation value table 501. The position evaluation value table 501 is composed of a plurality of pieces of position evaluation value information, each piece of which includes a distance range and a position evaluation value.

For example, position evaluation value information 502 includes a distance range “no more than 0.5” and a position evaluation value “0.7”. This indicates that a content evaluation value of a piece of content data photographed at a position whose slant distance from the home is no more than 0.5 km is “0.7”.

The position evaluation value table 501 may be prestored in the terminal device 100A before shipment of the terminal device 100A. Also, after shipment of the terminal device 100A, the position evaluation value table 501 may be changed by the user's operation.

The content acquisition unit 152 reads, from the position evaluation value table 501, a position evaluation value corresponding to a distance range that includes the calculated slant distance.

Also, instead of the position evaluation value table, the content acquisition unit 152 may store therein a predetermined function for calculating content evaluation values, and assign the calculated slant distance to the function to obtain the content evaluation value.

Next, the content acquisition unit 152 generates a piece of content evaluation value information including the read position evaluation value as the content evaluation value of the piece of content data, and adds the generated piece of content evaluation value information to the content evaluation value table 145.

The neighborhood of the home is where the user of the terminal device 100 A spends his daily life. A photograph taken near the home has a possibility to include information relating to the user more personally. In view of this possibility, in the modification (5-1), content evaluation values are set such that a shorter distance from the home corresponds to a higher content evaluation value.

Note that the structure is described here as an example, in which the position information indicating the position of the home is registered, and the content evaluation value is determined in accordance with the slant distance between the home and the photographing position. However, the present invention is not limited to this structure. A content evaluation value of a piece of content data may be determined in accordance with a distance between a photographing position of the piece of content data and a position deeply relating to the user of the terminal device 100A such as the user's office or school. Also, the following may be employed. There are no less than two pieces of position information to be registered. The content acquisition unit 152 calculates a slant distance between a position indicated by each piece of the position information and a photographing position of a piece of content data, and determines a content evaluation value of the piece of content data based on the longer one of the calculated slant distances.

(5-2) Generation of Content Evaluation Value in Accordance with Photographing Date

The terminal device 100A according to the first embodiment includes therein a clock function for calculating the current date.

When the photographing unit takes a photograph, the content acquisition unit 152 acquires a current date (photographing date). The photographing date is composed of time, day, week, month and year. Next, the content acquisition unit 152 writes apiece of content data, a content ID, and a photographing date into the storage unit 110 in correspondence with each other.

Then, the content acquisition unit 152 generates a content evaluation value in accordance with the acquired photographing date. For example, content evaluation values stored in the terminal device 100A may be set by default at the time of purchase thereof, such that a piece of content data photographed on Saturday or Sunday corresponds to a higher content evaluation value, and a piece of content data photographed on a weekday corresponds to a lower content evaluation value. Furthermore, a piece of content data photographed on a national holiday or a special day (Christmas, the New Year, Bon Festival, etc.) may correspond to a higher content evaluation value. Moreover, a piece of content data photographed on a specific day input by the user's operation (for example, an anniversary such as the user's birthday) may correspond to a higher content evaluation value.

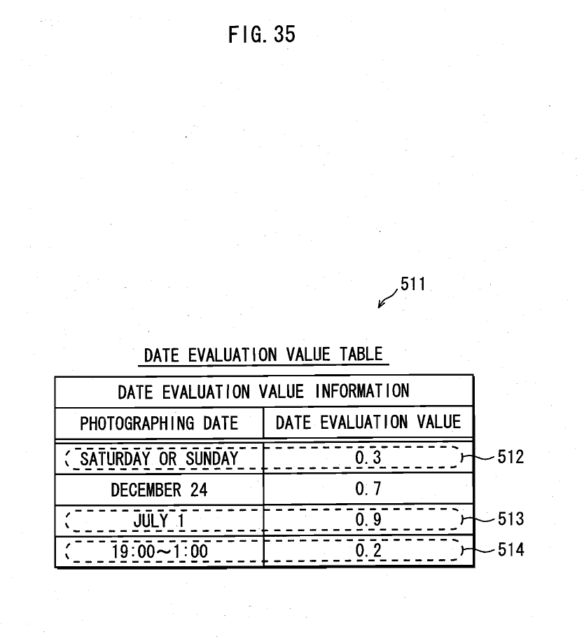

Specifically, the storage unit 110 stores therein a date evaluation value table 511 showing the correspondence between weeks or dates of special days and numeric values (decimal numbers from 0 to 1.0, herein after, referred to as “date evaluation values”). FIG. 35 shows an example of the structure of the date evaluation value table 511. The date evaluation value table 511 is composed of a plurality of pieces of date evaluation value information, each piece of which includes a photographing date, and a date evaluation value. For example, date evaluation value information S12 includes a photographing date “Saturday or Sunday” and a date evaluation value “0.3”. This indicates that a date evaluation value of a piece of content data photographed on Saturday or Sunday is “0.3”. Although the date evaluation value table 511 is prestored in the terminal device 100A at the time of sale thereof, a setting thereof is changed by the users, operations.

After writing the photographed piece of content data into the storage unit 110, the content acquisition unit 152 detects, from the date evaluation value table 511, a piece of date evaluation value information having an element that is the same as any one of time, day, week, month and year included in the photographing date of the piece of content data. If no piece of date evaluation value information having the same element can be detected, the content acquisition unit 152 determines a content evaluation value of the photographed piece of content data as “0”.

If a piece of date evaluation value information having the same element is detected, the content acquisition unit 152 reads a date evaluation value included in the detected piece of evaluation value information. Next, the content acquisition unit 152 generates a piece of content evaluation value information including the read date evaluation value as the content evaluation value of the photographed piece of content data, and adds the generated piece of content evaluation value information to the content evaluation value table 145.

Also, assume that a plurality of pieces of date evaluation value information corresponding to a photographing date are detected from the evaluation value table 511. If the photographing unit generates a piece of content data on Saturday Jul. 1, 2006 for example, both of the date evaluation value information 512 and 513 are detected. In this case, the content acquisition unit 152 reads date evaluation values “0.3” and “0.9” respectively included in the date evaluation value information 512 and 513. The content acquisition unit 152 compares the value “0.3” with the value “0.9”, and determines the greater value “0.9” as a content evaluation value of the generated piece of content data.

Also, instead of input of a specific date evaluation value by the user, the following structure may be employed. When the user inputs an only date of a special day such as an anniversary on which a piece of content data is photographed, a result of a predetermined calculation (such as 1.2 times of a normal date evaluation value of a piece of content data photographed on Saturday or Sunday) is used as a date evaluation value of the piece of content data photographed on the input date. Also, the following structure in conjunction with a schedule function or the like included in the terminal device may be employed. A date field in which a phrase “birthdate” or a pictogram representing the birth date is written is specified. A piece of date evaluation value including a date corresponding to the specified date field and a predetermined date evaluation value is generated, and the generated piece of date evaluation value is added to the evaluation value table 511.

With such a structure, without requiring operations by the user of the terminal device 100A, a higher content evaluation value can be given to a photograph that is taken on a date falling on (or expected to fall on) a private event day of the user and has a possibility to include many pieces of the user's personal information.

Furthermore, without limiting to the date evaluation value corresponding to a week or a date, the following may be employed. Each of the pieces of date evaluation value information may include a date evaluation value 514 corresponding to a time or a range of time (for example, 7:00 PM to 1:00 AM). A content evaluation value of a piece of content data photographed at a time corresponding to the date evaluation value 514 is set to have “0.2”.

(5-3) Content Evaluation Value Calculation in Accordance with Photographer's Condition

In the modification (5-3), the terminal device 100A includes a sensor for detecting biometric information of a photographer (such as a heart rate, blood pressure, and amount of perspiration).

The content acquisition unit 152 acquires biometric information of the photographer at the time of photographing, and writes the acquired biometric information into the storage unit 110 together with a piece of content data and a content ID.

Next, the content acquisition unit 152 determines a content evaluation value of the piece of content data in accordance with the acquired biometric information. For example, the content acquisition unit 152 increases the content evaluation value in accordance with a high heart rate of the photographer. Specifically, like the casein the above modification (5-1), the content acquisition unit 152 stores therein a table showing the correspondence between the range of heart rate and content evaluation values, and determines the content evaluation value using the table. Also, the content acquisition unit 152 may measure a plurality of pieces of biometric information, and determines the content evaluation value in accordance with the correlation between the pieces of biometric information.

(5-4) Content Evaluation Value Calculation in Accordance with Photographer

Assume that the terminal device 100A is shared among a plurality of users such as family members.

The terminal device 100A here includes a sensor for identifying a photographer (for example, a fingerprint authentication function).

The storage unit 110 stores therein, for each of users, an identifier indicating the user, a piece of fingerprint data of the user, and a user evaluation value of the user in correspondence with each other. When taking a photograph, the content acquisition unit 152 identifies a photographer using the sensor and a piece of fingerprint data stored in the storage unit 110. The content acquisition unit 152 writes an identifier indicating the identified photographer and the photographed piece of content data into the storage unit 110 in correspondence with each other.

Then, the content acquisition unit 152 reads a user evaluation value corresponding to the identified photographer, and determines the read user evaluation value as a content evaluation value of the photographed piece of content data.

(5-5) Content Evaluation Value Calculation in Accordance with Whether Additional Information is Acquired

The terminal device 100A of the modification (5-5) includes the GPS function, the clock function, the sensor for measuring biometric information, and the function for identifying photographers, which have been described in the above modifications (5-1) to (5-4). Note that the terminal device 100A does not necessarily need to include all the above functions, and the terminal device 100A may include at least any one of the above functions.

If the photographing unit takes a photograph, the content acquisition unit 152 acquires photographing position information, a photographing date, biometric information of a photographer, and identification information of the photographer, by using the GPS function, the clock function, the sensor for measuring biometric information, and the function for identifying photographers. Hereinafter, the photographing position information, the photographing date, the biometric information of the photographer, and the identification information of the photographer are generically referred to as “additional information”.

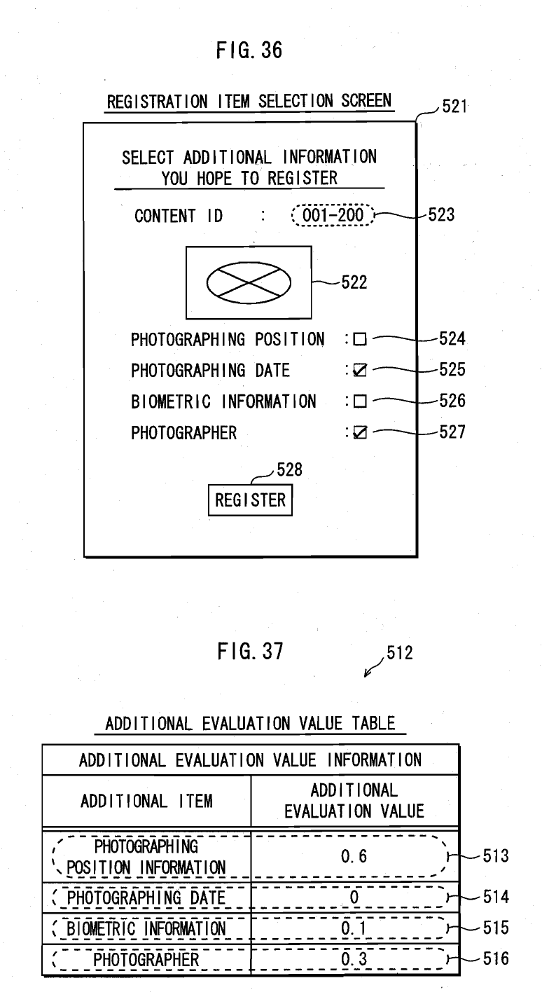

Next, the content acquisition unit 152 generates a registration item selection screen 521 for causing the user to select whether to save a piece of additional information corresponding to a piece of content data (the taken photograph), and displays the generated registration item selection screen 521 on the display unit 109. FIG. 36 shows an example of the registration item selection screen 521 generated here. The registration item selection screen 521 includes a content 522 taken by the photographing unit, a content ID 523 corresponding to the content 522, four check boxes 524 to 527, and a register button 528. The check boxes 524 to 527 respectively correspond to the photographing position information, the photographing date, the biometric information, and the identification information of the photographer, which have been acquired by the content acquisition unit 152.

The user checks the check boxes and presses the register button 528 by operating the direction keys, the determine key and the like included in the input unit 106, in order to select any piece included in the additional information that the user hopes to register. All the pieces included in the additional information may be selected, and also, all the pieces included in the additional information may not be selected.

Upon receiving the user's selection, the content acquisition unit 152 writes, into the storage unit 110 in correspondence with each other, the piece of content data, the content ID, and any selected piece among the photographing position information, the photographing date, the biometric information of the photographer, and the identification information of the photographer.

Moreover, the storage unit 110 stores therein an additional information evaluation value table 512 including additional evaluation values respectively corresponding to the pieces included in the additional information. FIG. 37 shows the details of the additional evaluation value table 512. As shown in FIG. 37, the additional evaluation value table 512 is composed of pieces of additional evaluation value information 513 to 516, each piece of which includes an additional item and an additional evaluation value. The additional evaluation value is a decimal number from 0 to 1.0. The sum of additional evaluation values included in all the pieces of additional evaluation information is 1.0. The additional item indicates an information name of any one of four pieces of information included in the additional information.

After writing the piece of content data, the content ID, and the selected pieces included in the additional information into the storage unit 110, the content acquisition unit 152 reads additional evaluation values respectively corresponding to the selected pieces included in the additional information from the additional evaluation value table 512, and calculates the sum of the read additional evaluation values. Then, the content acquisition unit 152 generates a piece of content evaluation value information including the sum of the calculated values as a content evaluation value of the piece of content data, and adds the generated piece of content evaluation value information to the content evaluation value table 145.

(5-6) Content Evaluation Value Calculation in Accordance with Elapsed Time Period from Photographing

Content evaluation values may be calculated in accordance with elapsed time periods from photographing content data.

When writing a piece of content data photographed by the photographing unit into the storage unit 110, the content acquisition unit 152 writes a photographing date of the piece of content data together therewith. At this time, the content acquisition unit 152 generates a piece of content evaluation value information, and adds the generated piece of content evaluation value information to the content evaluation value information table 145.

The content information setting unit 156 updates content evaluation values periodically (for example, at 4 AM every day). The content information setting unit 156 reads a photographing date of a piece of content data, calculates an elapsed time period from the read photographing date, and updates a content evaluation value of the piece of content data based on the calculated elapsed time. The content information setting unit 156 updates content evaluation values such that a lower content evaluation value corresponds to a longer elapsed time period from a photographing date, and a higher content evaluation value corresponds to a shorter elapsed time period from a photographing date. Specifically, like the case in the modification (5-1), the storage unit 110 stores therein a table showing the correspondence between the ranges of elapsed time periods and evaluation values. The content information setting unit 156 reads a content evaluation value corresponding to the calculated elapsed time period from this table. Then, the content information setting unit 156 updates a content evaluation value included in a piece of content evaluation value information corresponding to the piece of content data to the read content evaluation value.

Also, in the modification (5-6), instead of storing therein the content evaluation value table, the terminal device 100A may have the following structure. When transmitting a piece of content data, the terminal device 100A calculates an elapsed time period from photographing of the piece of content data selected as a transmission target, and determines a content evaluation value of the piece of content data based on the calculated elapsed time period.

(5-7) Content Evaluation Value Calculation in Accordance with the Sum of the Number of Transmission Times

Furthermore, the following structure may be employed. The sum of transmission times for each piece of content data is counted, and a content evaluation value of the piece of content data is decreased in accordance with the sum of transmission times thereof.

In this case again, the storage unit 110 stores therein a table showing the correspondence between the ranges of the sum of transmission times and evaluation values. After transmission of a piece of content data by the transmission processing unit 157 and updating of an entity evaluation value by the entity evaluation value derivation unit 156, the content information setting unit 153 reads, from this table, a content evaluation value corresponding to the number of transmission times of the piece of content data. Next, the content information setting unit 153 selects a piece of content evaluation value information corresponding to the transmitted piece of content data, and updates a content evaluation value included in the selected piece of content evaluation value information to the read content evaluation value.

(5-8) Content Evaluation Value Calculation in Accordance with Face Images Included in Terminal Device

In the modification (5-8), the terminal device 100A includes an image analysis function.

The terminal device 100A stores therein, by default, face images of specific persons such as the user of the terminal device 100A, the user's family members, and the user's friends. The terminal device 100A generates a content evaluation value of a piece of content data in accordance with whether any of the stored face images is included in the piece of content data, how many persons whose face images are stored the piece of content data includes, or the like.

Specifically, the user registers, by default, photographs of the user, the user's close relatives such as family members and friends (herein after, referred to as “registered face images”). Also, the user registers image evaluation values respectively corresponding to the registered face images (decimal numbers from 0 to 1.0).

The content acquisition unit 152 specifies a face image included in a piece of content data using the image analysis function, and compares the specified face image with the registered face images.

If any of the registered face images is included in the piece of content data, the content acquisition unit 152 reads an image evaluation value corresponding to the registered face image included in the piece of content data. Next, the content acquisition unit 152 generates a piece of content evaluation value information including the read image evaluation value as a content evaluation value of the piece of content data, and adds the generated piece of content evaluation value information to the content evaluation value table 145.

If a plurality of the registered face images are included in the piece of content data, the content acquisition unit 152 reads image evaluation values respectively corresponding to the registered face images, and selects the highest value among the read image evaluation values as a content evaluation value of the piece of content data.

Moreover, the content acquisition unit 152 may determine the sum of the read image evaluation values as the content evaluation value.

(5-9) Content Evaluation Value Calculation in Accordance with Content Data Size

The terminal device 100A may determine a content evaluation value of a piece of content data in accordance with the data size thereof.

Specifically, the storage unit 110 stores therein a table showing the correspondence between the ranges of data size and content evaluation values of pieces of content data having a data size within the range (for example, a table having the same structure as that of the position evaluation value table 501 described in the above modification (5-1).). Here, evaluation values in the table are set such that a piece of content data having a larger data size corresponds to a higher evaluation value.

The content acquisition unit 152 reads an evaluation value corresponding to a photographed piece of content data from the table. The content acquisition unit 152 generates a piece of content evaluation value information including the read evaluation value, and adds the generated piece of content evaluation value information to the content evaluation value table.

Moreover, the content acquisition unit 152 may determine a content evaluation value in accordance with the resolution of the piece of content data instead of the data size of content data.

(5-10) Content Evaluation Value Calculation in Accordance with Keyword Included in E-Mail

Although not have been described in the above embodiments, content data is transmitted/received as an e-mail attachment. A content evaluation value may be determined in accordance with texts of an e-mail to which the content data is attached.

Specifically, the terminal device 100A of the modification (5-10) stores therein a specific keyword and an evaluation value corresponding to the specific keyword (herein after, a “keyword evaluation value”) in correspondence with each other.

When a piece of content data is transmitted as an e-mail attachment, the content information setting unit 153 detects keywords from an e-mail text, and calculates the sum of keyword evaluation values corresponding to the detected keywords. Keywords and the procedure of detecting the keywords are the same as those of the modification (9), which are described later. The content information setting unit 153 updates a content evaluation value included in a piece of content evaluation value information corresponding to the transmitted piece of content data, to the calculated sum.

In this case, each time an e-mail having attached thereto a piece of content data is transmitted, a content evaluation value of the piece of content data is updated. Therefore, the entity evaluation value derivation unit 156 periodically re-calculates an entity evaluation value of a terminal device to which the piece of content data is transmitted, based on a transmission history. The details of entity evaluation value updating using the transmission history are the same as the case in the modification (1).

(6) In the first embodiment, content data has been described specifically as a photograph in JPEG format. However, the present invention is not limited this. The content data may be video data, music data, text data, and so on.

(7) In the second embodiment, the terminal device 300 determines entity evaluation values based on profiles in text format (personal information). However, the present invention is not limited this. The entity evaluation values may be determined based on image data such as photographs and illustrations, sound data, video data, document files, and so on.

Furthermore, without limiting to the profiles such as names and phone numbers of the users of the terminal devices, as long as the uniform rule regarding data type is defined within the information distribution system, the entity evaluation value may be determined based on any information. In this case again, like the case in the second embodiment, the terminal device 300 stores therein a table showing the correspondence between type IDs indicating data types of pieces of data used for calculating entity evaluation values (corresponding to profile IDs in the second embodiment) and data evaluation values of pieces of data belonging to the data type (corresponding to a profile evaluation value in the second embodiment) When receiving a piece of data having a type ID attached thereto from another terminal device, or when receiving the user's input of a piece of data on a displayed input screen, the terminal device 300 generates an entity evaluation value using the table.

(8) The first and second embodiments and the above modifications have been described using the information distribution system as an example, which controls whether content data transmission is permitted and whether secondary distribution is permitted using generated entity evaluation values. In this system, when secondary distribution of content data received from another terminal device is performed, entity evaluation values are used for determining whether the secondary distribution is permitted. Moreover, entity evaluation values are also used for generating secondary distribution thresholds for controlling transfer of content data from a transmission destination of the content data to yet another terminal device.

However, the use of entity evaluation values is not limited to these. The entity evaluation values may be used for another purposes.

For example, generated entity evaluation values are displayed on the display f or viewing by users. Also, a list of entity evaluation values is generated, and is exchanged between the terminal device 100A and other terminal devices. A user of a terminal device uses entity evaluation values written in the list received from another terminal device as a criterion for judging the degree of reliability of trading partners and communication partners in peer-to-peer service systems as typified by online auction services and file exchange services.

Also, reception of data transmitted from a terminal device having an entity evaluation value that is less than a predetermined threshold may be automatically rejected.

Furthermore, entity evaluation values may be used, as direct evaluation values used in the above Nonpatent Document 1, for calculating indirect evaluation values. In this way, entity evaluation values may be used for calculating other criteria.

The uses described here are just examples, and entity evaluation values may be used for various kinds of purposes.

(9) In the first and second embodiments, an evaluation value of a piece of information transmitted or acquired by a terminal device (a piece of content data in the first embodiment and a profile in the second embodiment) is specified. Then, an entity evaluation value is determined using the evaluation value of the piece of information. Alternatively, an entity evaluation value may be generated based on data included in information created by the user of the terminal device (such as a specific keyword). The following describes an example of this case.

Like the case in the first embodiment, the terminal device stores therein an other-terminal information table. Each piece of other-terminal information includes at least one registered name (such as a real name, just a family name, and a nickname of a user of a terminal device).

Furthermore, the terminal device stores therein specific keywords and evaluation values respectively corresponding thereto (referred to as “keyword evaluation values”). Keywords and keyword evaluation values may be registered beforehand, or may be input by the user. For example, the terminal device stores therein keyword evaluation values “+0.1”, “+0.2”, and “+0.5” that respectively correspond to keywords “enjoy”, “happy”, and “like” representing positive feelings. Also, the terminal device stores therein keyword evaluation values “−0.5” and “−0.3” that respectively correspond to keywords “dislike” and “sad” representing negative feelings.

The user creates a document that is a source from which an entity evaluation value is derived. For example, the user writes a diary.

When the diary is updated, the entity evaluation value derivation unit performs a text search of an updated part for any of the registered names included in the other-terminal information table. If detecting the registered name, then the entity evaluation value derivation unit detects any of the stored keywords from the updated part.

Here, as a specific example, assume that the user writes in the diary as follows: “Today, I went to see the movie with Hanako. I enjoyed.”. The entity evaluation value derivation unit detects the registered name “Hanako” and the keyword “enjoy”. Then, the entity evaluation value derivation unit adds the keyword evaluation value “+0.1” corresponding to the keyword “happy” to an entity evaluation value corresponding to the registered name “Hanako”. Note that the search may be performed in arbitrary units such as in units of paragraph, in units of document, and in units of file.

As described, entity evaluation values may be generated using keywords included in the user's diary.

(10) Moreover, in the above modification (9), a document that is a source from which an entity evaluation value is derived is not limited to a diary, and other document data such as e-mails may be employed.

Furthermore, a source from which an entity evaluation value is derived is not limited to documents created by the user of the terminal device. Alternatively, the terminal device may receive document data from another terminal device, and perform the text search of the acquired data similar to the above case to generate an entity evaluation value.

Also, in this case, based on a keyword evaluation value corresponding to a keyword included in the received document data, the terminal device may generate an entity evaluation value corresponding to a terminal device that is a transmission source of the document data.

(11) In the second embodiment, the terminal device 300 calculates an entity evaluation value of a terminal device to which a profile is transmitted, based on a product of a profile evaluation value of the profile and a specific gravity value corresponding to an acquisition path of the profile. However, without limiting to the acquisition path of the profile, weighting may be performed in accordance other conditions.

As an example, weighting may be performed depending on whether a received profile has a digital signature attached thereto. Specifically, if receiving a profile having a digital signature attached thereto, the terminal device 300 sets a larger specific gravity value compared with a case of receiving the profile having no digital signature attached thereto.

Also, if a received profile is a phone number, the terminal device 300 judges whether the received phone number is a mobile phone number or a fixed-line phone number. The terminal device 300 multiplies a profile evaluation value of the received phone number by a different specific gravity value depending on whether the phone number is a mobile phone number or a fixed-line phone number.

Specifically, the terminal device 300 sets a larger specific gravity value corresponding to a fixed-line phone number than a specific gravity value corresponding to the mobile phone number.

(12) Each of the above devices is specifically a computer system composed of a microprocessor, a ROM, a RAM, a hard disk unit, a display unit, a keyboard, a mouse, and so on. A computer program is stored in the RAM, the ROM, and the hard disk unit. Functions of each of the devices are achieved by the microprocessor operating in accordance with the computer program. Here, the computer program is composed of a plurality of instruction codes that show instructions to the computer, in order to achieve predetermined functions.

(13) All or part of compositional elements of each of the above devices may be composed of a single system LSI (Large Scale Integration). The system LSI is a super-multifunctional LSI manufactured by integrating a plurality of compositional units on a single chip, and is specifically a computer system composed of a microprocessor, a ROM, a RAM, and so on. A computer program is stored in the RAM. Functions of the system LSI are achieved by the microprocessor operating in accordance with the computer program.

Here, the LSI may be called an IC, a system LSI, a super LSI, and an ultra LSI, depending on the degree of integration.

Also, a method of forming integrated circuits is not limited to LSIs, and may be realized using a dedicated circuit or a general-purpose processor. Furthermore, an FPGA (Field Programmable Gate Array) that is programmable after manufacturing LSIs and a reconfigurable processor that can reconfigure connection and setting of circuit cells inside LSIs may be used.

Furthermore, when new technology for forming integrated circuits that replaces LSIs becomes available as a result of progress in semiconductor technology or semiconductor-derived technology, functional blocks may be integrated using such technology. One possibility lies in adaptation of biotechnology.

(14) All or part of the compositional elements of each of the above devices may be composed of a removable IC card or a single module. The IC card or the single module is a computer system composed of a microprocessor, a ROM, a RAM, and so on. The IC card or the module may include the above-described super-multifunctional LSI. Functions of the IC card or the module are achieved by the microprocessor operating in accordance with the computer program. The IC card or the module may be tamper-resistant.

(15) The present invention may be the above methods. Also, the present invention may be a computer program that realizes the methods by a computer, or a digital signal composed of the computer program.

Furthermore, the present invention may be a computer-readable storage medium such as a flexible disk, a hard disk, a CD-ROM, an MO, a DVD, a DVD-ROM, a DVD-RAM, a BD (Blu-ray Disc), and a semiconductor memory, which stores therein the computer program or the digital signal. Furthermore, the present invention may be the computer program or the digital signal stored in the storage medium.

Furthermore, the present invention may be the computer program or the digital signal transmitted via an electric communication line, a wireless or wired communication line, a network such as the Internet, data broadcasting, and so on.

Furthermore, the present invention may be a computer system that includes a microprocessor and a memory, the memory storing the above computer program, and the microprocessor operating in accordance with the computer program.

Furthermore, the program or the digital signal may be executed by other independent computer system, by transferring the program or the digital signal stored in the storage medium, or by transferring the program or the digital signal via the network or the like.

(16) The present invention may be any combination of the above-described embodiments and modifications.

### INDUSTRIAL APPLICABILITY

The art relating to the present invention is useful in systems, devices, and the like for generating evaluation values that quantitatively represent evaluation results of equipments exchanging information and users thereof. Also, the present invention is available administratively, repeatedly, and continuously in the industry that manufactures and sells the devices that generate the evaluation values and the industry that provides various kinds of information and services using the generated evaluation values.

1. An evaluation device that generates an evaluation value representing an evaluation of an owner of a terminal device to which data is transmitted, the evaluation device comprising:
a storage unit that stores therein one or more pieces of data and data evaluation values respectively corresponding thereto;
a terminal designation unit operable to receive designation of a terminal device from an operator of the evaluation device;
a data designation unit operable to receive designation of a piece of data to be transmitted to the designated terminal device from the operator, the piece of data being included in the stored pieces of data; and
a generation unit operable to generate an evaluation value of an owner of the designated terminal device, based on a data evaluation value corresponding to the designated piece of data.

2. The evaluation device of claim 1, wherein
the storage unit stores therein the data evaluation values determined by the operator.

3. The evaluation device of claim 2, wherein
the generation unit selects, as the evaluation value of the owner, a highest value among the data evaluation value corresponding to the designated piece of data and a data evaluation value corresponding to a piece of data that has ever been designated to be transmitted to the designated terminal device.

4. The evaluation device of claim 3, wherein
the generation unit includes:
an old evaluation value storage sub-unit that stores therein an old evaluation value representing an evaluation of the owner that has been generated before the data designation unit and the terminal designation unit receive the designation of the terminal device and the piece of data;
a comparison sub-unit operable to compare the old evaluation value with the data evaluation value corresponding to the designated piece of data, and select a highest value of the old evaluation value and the data evaluation value, as the evaluation value of the owner; and
an updating sub-unit operable to update the old evaluation value to the selected evaluation value.

5. The evaluation device of claim 3, wherein
the generation unit includes:
a history storage sub-unit that stores therein history information indicating the piece of data that has ever been designated to be transmitted to the designated terminal device; and
a selection sub-unit operable to select the highest value among the data evaluation value corresponding to the designated piece of data and the data evaluation value corresponding to the piece of data indicated by the history information.

6. The evaluation device of claim 2, wherein
the generation unit generates, as the evaluation value of the owner, a sum of the data evaluation value corresponding to the designated piece of data and a data evaluation value corresponding to a piece of data that has ever been designated to be transmitted to the designated terminal device.

7. The evaluation device of claim 6, wherein
the generation unit includes:
an old evaluation value storage sub-unit that stores therein an old evaluation value representing an evaluation of the owner that has been generated before the data designation unit and the terminal designation unit receive the designation of the terminal device and the piece of data;
a calculation sub-unit operable to calculate a sum of the old evaluation value and the data evaluation value corresponding to the designated piece of data; and
an updating sub-unit operable to update the old evaluation value to the calculated sum.

8. The evaluation device of claim 6, wherein
the generation unit includes:
a history storage sub-unit that stores therein history information indicating the piece of data that has ever been designated to be transmitted to the designated terminal device; and
a calculation sub-unit operable to calculate a sum of the data evaluation value corresponding to the piece of data indicated by the history information and the data evaluation value corresponding to the designated piece of data.

9. The evaluation device of claim 1 further comprising:
an acquisition unit operable to acquire apiece of data relating to the owner; and
an evaluation value generation unit operable to generate an evaluation value of the owner in accordance with a data type of the acquired piece of data.

10. The evaluation device of claim 9, wherein
the evaluation value generation unit includes:
a type evaluation value storage sub-unit that stores therein one or more type evaluation values respectively corresponding to one or more data types; and
a calculation sub-unit operable to read a type evaluation value corresponding to the data type of the acquired piece of data among the type evaluation values stored in the type evaluation value storage sub-unit, and calculate the evaluation value of the owner using the read type evaluation value.

11. The evaluation device of claim 10, wherein
the acquisition unit acquires the piece of data that is personal data of the owner.

12. The evaluation device of claim 10 further comprising
an input unit operable to receive the type evaluation value input by the operator, wherein
the type evaluation value storage unit stores therein the type evaluation value received by the input unit.

13. The evaluation device of claim 10, wherein
the acquisition unit acquires the piece of data including an identifier indicating the data type thereof,
the type evaluation values stored in the type evaluation value storage unit respectively correspond to identifiers respectively indicating the data types, and
the calculation sub-unit reads the type evaluation value corresponding to the identifier included in the acquired piece of data.

14. The evaluation device of claim 10, wherein
the acquisition unit receives the piece of data relating to the owner from the designated terminal device via a network.

15. The evaluation device of claim 10, wherein
the acquisition unit acquires the piece of data relating to the owner via input by the operator.

16. The evaluation device of claim 10, wherein
the acquisition unit acquires the piece of data relating to the owner by receiving from the designated terminal device via a network or receiving input by the operator, and
the calculation sub-unit calculates the evaluation value of the owner using a product of the type evaluation value corresponding to the data type of the acquired piece of data and a specific gravity value corresponding to a method for acquiring the piece of data.

17. The evaluation device of claim 9, wherein
the evaluation value generation unit includes:
a type evaluation value storage sub-unit that stores therein one or more type evaluation values respectively corresponding to one or more data types; and
an old evaluation value storage sub-unit that stores therein an old evaluation value representing an evaluation of the owner generated in accordance with one or more data types of one or more pieces of data relating to the owner that have ever been acquired;
a judgment sub-unit operable to judge whether the data type of the acquired piece of data matches the data types of the pieces of data that have ever been acquired; and
a calculation sub-unit operable, (i) if the judgment sub-unit judges negatively, to read a type evaluation value corresponding to the data type of the acquired piece of data from the type evaluation value storage unit, and calculate the evaluation value of the owner based on the read type evaluation value and the old evaluation value, and (ii) if the judgment sub-unit judges affirmatively, to determine the old evaluation value as the evaluation value of the owner.

18. An evaluation method for use in an evaluation device that generates an evaluation value representing an evaluation of an owner of a terminal device to which data is transmitted,
the evaluation device comprising
a storage unit that stores therein one or more pieces of data and data evaluation values respectively corresponding thereto,
the evaluation method comprising:
a terminal designation step for receiving designation of a terminal device from an operator of the evaluation device;
a data designation step for receiving designation of a piece of data to be transmitted to the designated terminal device from the operator, the piece of data being included in the stored pieces of data; and
a generation step for generating an evaluation value of an owner of the designated terminal device, based on a data evaluation value corresponding to the designated piece of data.

19. The evaluation method of claim 18 further comprising:
an acquisition step for acquiring a piece of data relating to the owner; and
an evaluation value generation step for generating an evaluation value of the owner in accordance with a data type of the acquired piece of data.

20. An evaluation program for use in an evaluation device that generates an evaluation value representing an evaluation of an owner of a terminal device to which data is transmitted,
the evaluation device comprising
a storage unit that stores therein one or more pieces of data and data evaluation values respectively corresponding thereto,
the evaluation program comprising:
a terminal designation step for receiving designation of a terminal device from an operator of the evaluation device;
a data designation step for receiving designation of a piece of data to be transmitted to the designated terminal device from the operator, the piece of data being included in the stored pieces of data; and
a generation step for generating an evaluation value of an owner of the designated terminal device, based on a data evaluation value corresponding to the designated piece of data.

21. The evaluation program of claim 20 further comprising:
an acquisition step for acquiring a piece of data relating to the owner; and
an evaluation value generation step for generating an evaluation value of the owner in accordance with a data type of the acquired piece of data.

22. An integrated circuit implemented in an evaluation device that generates an evaluation value representing an evaluation of an owner of a terminal device to which data is transmitted,
the integrated circuit comprising:
a storage unit that stores therein one or more pieces of data and data evaluation values respectively corresponding thereto;
a terminal designation unit operable to receive designation of a terminal device from an operator of the evaluation device;
a data designation unit operable to receive designation of a piece of data to be transmitted to the designated terminal device from the operator, the piece of data being included in the stored pieces of data; and
a generation unit operable to generate an evaluation value of an owner of the designated terminal device, based on a data evaluation value corresponding to the designated piece of data.

23. The integrated circuit of claim 22 further comprising:
an acquisition unit operable to acquire a piece of data relating to the owner; and
an evaluation value generation unit operable to generate an evaluation value of the owner in accordance with a data type of the acquired piece of data.
